(19) United States
(12) Patent Application Publication
(10) Pub. No.: US 2017/0355817 A1
(43) Pub. Date: Dec. 14, 2017

(54) COPOLYCARBONATE COMPOSITIONS WITH IMPROVED PROCESSING BEHAVIOUR CONTAINING PE-WAX

(71) Applicant: Covestro Deutschland AG, Leverkusen (DE)

(72) Inventors: Rolf WEHRMANN, Krefeld (DE); Helmut Werner HEUER, Leverkusen (DE)

(21) Appl. No.: 15/532,564

(22) PCT Filed: Dec. 2, 2015
(86) PCT No.: PCT/EP2015/078271

§ 371 Date: Jun. 2, 2017

(30) Foreign Application Priority Data
Dec. 4, 2014 (EP) 14196208.4

(51) Int. Cl. C08G 64/12; C08L 69/00; C08L 23/26; B01J 31/02; C08F 10/02

(52) U.S. Cl. CPC C08G 64/12; C08L 69/00; C08L 23/26; C08F 10/02; B01J 31/0268

(57) ABSTRACT

The invention relates to copolycarbonate compositions containing oxidized, acid-modified polyethylene wax, to their use for producing blends and moldings and to moldings obtained therewith. Said copolycarbonate compositions have an improved processing behaviour.

The invention relates to copolycarbonate compositions comprising oxidized, acid-modified polyethylene waxes, to the use thereof for producing blends, moldings and to moldings obtainable therefrom. The copolycarbonate compositions exhibit improved flowability and thus improved processing behavior.

Copolycarbonates belong to the group of technical thermoplastics. They find versatile application in the electrical and electronics sectors, as a housing material of lamps and in applications where particular thermal and mechanical properties are required, for example hairdryers, applications in the automobile sector, plastic covers, reflectors, diffusers or light conducting elements and lamp covers or lamp bezels. These copolycarbonates may be used as blend partners for further thermoplastic plastics materials.

In these compositions good thermal and mechanical properties such as a high Vicat temperature (heat distortion resistance) and glass transition temperature are practically always compulsory. However, at the same time high glass transition temperatures and heat distortion resistances also result in relatively high melt viscosities which in turn has a negative effect on processability, for example in injection molding.

The flowability of (co)polycarbonate compositions/(co)PC blends can be increased by the addition of low molecular weight compounds. Since substances of this kind, however, simultaneously act as plasticizers, they lower the heat distortion resistance and glass transition temperature of the polymer matrix. This in turn is undesirable, since this reduces the temperature use range of the materials.

DE 102004020673 describes copolycarbonates having improved flowability based on bisphenols having an ether/thioether linkage.

DE 3918406 discloses blends for optical data storage means, based on a specific polycarbonate with elastomers or other thermoplastics and the use thereof in optical applications, specifically optical data storage means such as compact disks.

EP 0 953 605 describes linear polycarbonate compositions having improved flow characteristics obtained when cyclic oligocarbonates are added in large amounts, for example 0.5% to 4%, and homogenized in the matrix of a linear BPA polycarbonate at 285° C. by means of a twin-shaft extruder. In the course of this, the flowability increases as the amount of cyclic oligocarbonates rises. At the same time, however, there is a distinct decrease in the glass transition temperature and hence the heat distortion resistance. This is undesirable in the industrial applications of (co)polycarbonate compositions having relatively high heat distortion resistances. This disadvantage then has to be compensated for through the use of higher amounts of costly cobisphenols.

The conventional way of improving flow is to use BDP (bisphenol A diphosphate), in amounts of up to more than 10 wt %, in order to achieve the desired effect. However, this causes a very severe reduction in heat distortion resistance.

The prior art does not provide one skilled in the art with any indication of how to improve the flowability of (co)polycarbonate compositions/of PC blends for a predetermined/defined heat distortion resistance.

The present invention accordingly has for its object to provide compositions comprising aromatic polycarbonate compositions which exhibit an improved flowability while heat distortion resistance remains virtually constant.

It was found that, surprisingly, the addition of oxidized acid-modified polyethylene waxes to copolycarbonate compositions results in improved rheological properties, the thermal and mechanical properties remaining practically unchanged.

The described novel property combinations are an important criterion for the mechanical and thermal performance of injection molded/extruded components produced therefrom. Injection moldings or extrudates produced from the copolycarbonate compositions according to the invention have significantly improved flow properties without a deterioration in thermal properties.

The invention therefore provides copolycarbonate compositions comprising
A) 67.0 to 99.95 wt % of at least one copolycarbonate comprising monomer units selected from the group consisting of the structural units of general formulae (1a), (1b), (1c) and (1d)

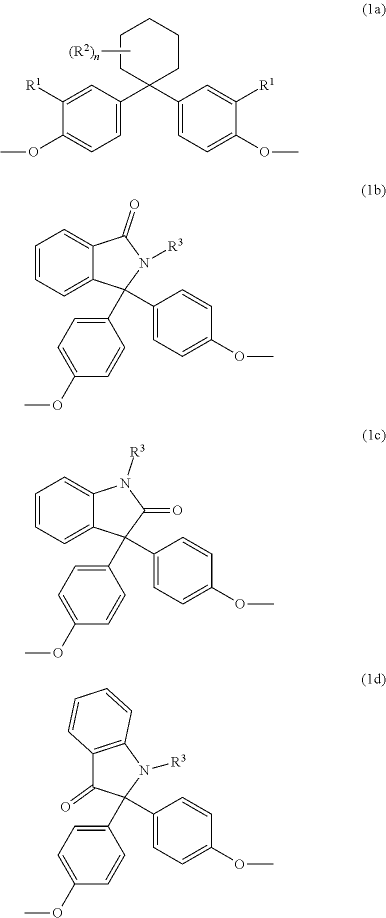

in which
   R′ represents hydrogen or C₁-C₄-alkyl, preferably hydrogen,
   R² represents C₁-C₄-alkyl, preferably methyl,
   n represents 0, 1, 2 or 3, preferably 3, and
   R³ represents C₁-C₄-alkyl, aralkyl or aryl, preferably methyl or phenyl, very particularly preferably methyl,
or
67.0 to 99.95 wt % of a blend of the one or more copolycarbonates and at least one further homo- or copolycarbonate comprising one or more monomer units of general formula (2):

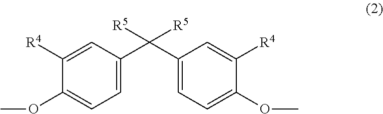

in which
   R⁴ represents H, linear or branched C₁-C₁₀ alkyl, preferably linear or branched C₁-C₆ alkyl, particularly preferably linear or branched C₁-C₄ alkyl, very particularly preferably H or C₁-alkyl (methyl), and
   R⁵ represents linear or branched C₁-C₁₀ alkyl, preferably linear or branched C₁-C₆ alkyl, particularly preferably linear or branched C₁-C₄ alkyl, very particularly preferably C₁-alkyl (methyl);
wherein the optionally present further homo- or copolycarbonate has no monomer units of formulae (1a), (1b), (1c) and (1d);
B) 0.05 to 10.0 wt % of at least one oxidized acid-modified polyethylene wax; and
C) 0 to 30.0 wt % of one or more additives and/or

Definitions

C₁-C₄-Alkyl in the context of the invention represents for example methyl, ethyl, n-propyl, isopropyl, n-butyl, sec-butyl, tert-butyl, C₁-C₆-alkyl moreover represents for example n-pentyl, 1-methylbutyl, 2-methylbutyl, 3-methylbutyl, neo-pentyl, 1-ethylpropyl, cyclohexyl, cyclopentyl, n-hexyl, 1,1-dimethylpropyl, 1,2-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl or 1-ethyl-2-methylpropyl, C₁-C ₁₀-alkyl moreover represents for example n-heptyl and n-octyl, pinacyl, adamantyl, the isomeric menthyls, n-nonyl, n-decyl, C₁-C₃₄-alkyl moreover represents for example n-dodecyl, n-tridecyl, n-tetradecyl, n-hexadecyl or n-octadecyl. The same applies for the corresponding alkyl radical for example in aralkyl/alkylaryl, alkylphenyl or alkylcarbonyl radicals. Alkylene radicals in the corresponding hydroxyalkyl or aralkyl/alkylaryl radicals represent for example the alkylene radicals corresponding to the preceding alkyl radicals.

Aryl represents a carbocyclic aromatic radical having 6 to 34 skeletal carbon atoms. The same applies for the aromatic part of an arylalkyl radical, also known as an aralkyl radical, and for aryl constituents of more complex groups, for example arylcarbonyl radicals.

Examples of C₆-C₃₄-aryl are phenyl, o-, p-, m-tolyl, naphthyl, phenanthrenyl, anthracenyl and fluorenyl.

Arylalkyl and aralkyl each independently represent a straight-chain, cyclic, branched or unbranched alkyl radical as defined above which may be mono-, poly- or persubstituted by aryl radicals as defined above.

The above lists are illustrative and should not be regarded as limiting.

In the context of the present invention, ppb and ppm are understood to mean parts by weight unless stated otherwise.

In the context of the present invention—unless explicitly stated otherwise—the stated wt % values for the components A, B and C are each based on the total weight of the composition. The composition may contain further components in addition to components A, B and C. In a preferred embodiment the composition consists of the components A, B and optionally C.

Component A

The copolycarbonate composition according to the invention comprises as component A 67.0 to 99.95 wt % of a copolycarbonate comprising one or more monomer units of formulae (1a), (1b), (1c) and (1 d) or of a blend of the copolycarbonate comprising one or more monomer units of formulae (1a), (1b), (1c) and (1d) and a further homo- or copolycarbonate comprising one or more monomer units of general formula (2).

It is preferable when component A is present in the composition in an amount of 70.0 to 99.0 wt %, preferably 80.0 to 99.0 wt % and particularly preferably 85.0 to 98.5 wt %, in each case based on the total weight of the composition.

In a preferred embodiment the amount of the copolycarbonate comprising one or more monomer unit(s) of general formulae (1a), (1b), (1c) and (1d) in the composition is at least 50 wt %, particularly preferably at least 60 wt %, very particularly preferably at least 75 wt %.

The monomer unit(s) of general formula (la) is/are introduced via one or more corresponding diphenols of general formula (1a):

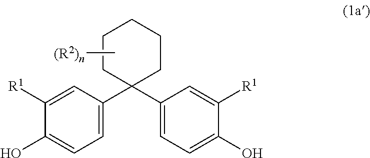

in which
R′ represents hydrogen or C₁-C₄-alkyl, preferably hydrogen,
R² represents C₁-C₄-alkyl, preferably methyl, and
n represents 0, 1, 2 or 3, preferably 3.

The diphenols of formulae (I a) to be employed in accordance with the invention and the employment thereof in homopolycarbonates are disclosed in DE 3918406 for example.

Particular preference is given to 1,1-bis(4-hydroxyphenyl)-3,3,5-trimethylcyclohexane (Bisphenol. TMC) having the formula (1a′):

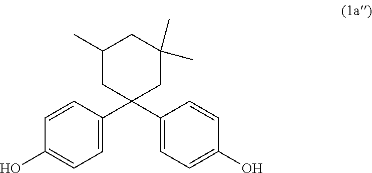 [SMILES: CC1CC(C)(C)CC(c2ccc(O)cc2)(c2ccc(O)cc2)C1]

The monomer unit(s) of general formula (1b), (1c) and (1d) are introduced via one or more corresponding diphenols of general formulae (1b), (1c′) and (1d′):

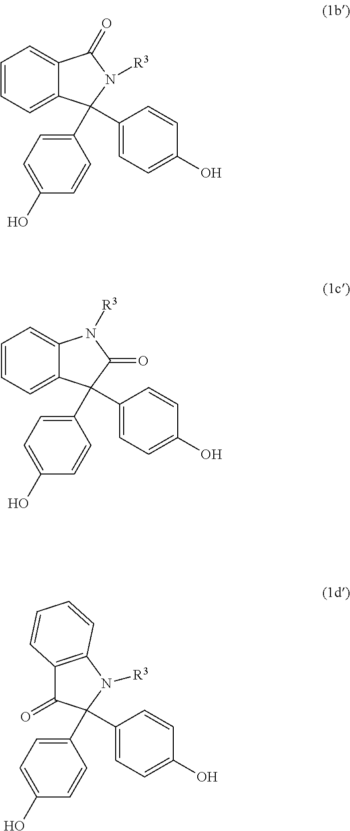

in which R³ represents C₁-C₄-alkyl, aralkyl or aryl, preferably methyl or phenyl, very particularly preferably methyl,

In addition to one or more monomer units of formulae (1a), (1b), and (1d) the copolycarbonate of component A may comprise one or more monomer unit(s) of formula (3):

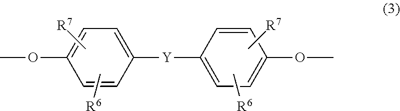

in which
R⁶ and R⁷ independently of one another represent H, C₁-C₁₈-alkyl-, C₁-C₁₈-alkoxy, halogen such as Cl or Br or respectively optionally substituted aryl or aralkyl, preferably H or C₁-C₁₂-alkyl, particularly preferably H or C₁-C₈-alkyl and very particularly preferably H or methyl, and

Y represents a single bond, —SO₂—, —CO—, —O—, —S—, C₁-C₆-alkylene or C₂-C₅-alkylidene, furthermore C₆-C₁₂-arylene, which may optionally be fused with further heteroatom-comprising aromatic rings.

The monomer unit(s) of general formula (3) are introduced via one or more corresponding diphenols of general formula (3a):

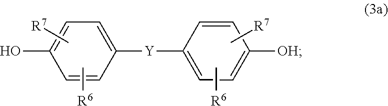

wherein R⁶, R⁷ and Y each have the meanings stated above in connection with formula (3).

Examples of the diphenols of formula (3a) which may be employed in addition to the diphenols of formula (1a′), (1b′), (1c′) and (1d′) include hydroquinone, resorcinol, dihydroxybiphenyls, bis(hydroxyphenyl)alkanes, bis(hydroxyphenyl)sulfides, bis(hydroxylphenyl) ethers, bis(hydroxyphenyl)ketones, bis(hydroxyphenyl)sulfones, bis(hydroxylphenyl)sulfoxides, α,α-'bis(hydroxyphenyl)diisopropylbenzenes and the ring-alkylated and ring-halogenated compounds thereof and also α,ω-bis(hydroxylphenyl)polysiloxanes.

Preferred diphenols of formula (3a) are for example 4,4′-dihydroxybiphenyl (DOD), 4,4′-dihydroxybiphenyl ether (DOD ether), 2,2-bis(4-hydroxyphenyl)propane (bisphenol A), 2,4-bis(4-hydroxyphenyl)-2-methylbutane, 1,1-bis(4-hydroxyphenyl)-1-phenylethane, 1,1-bis[2-(4-hydroxyphenyl)-2-propyl]benzene, 1,3-bis[2-(4-hydroxyphenyl)-2-propyl]-benzene (bisphenol M), 2,2-bis(3-methyl-4-hydroxyphenyl)propane, 2,2-bis(3-chloro-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl)sulfone, 2,4-bis(3,5-dimethyl-4-hydroxyphenyl)-2-methylbutane, 2,2-bis(3,5-dichloro-4-hydroxyphenyl)propane and 2,2-bis(3,5-dibromo-4-hydroxyphenyl)propane.

Particularly preferred diphenols are for example 2,2-bis(4-hydroxyphenyl)propane (bisphenol A), 4,4′-dihydroxybiphenyl (DOD), 4,4′-dihydroxybiphenyl ether (DOD ether), 1,3-bis[2-(4-hydroxyphenyl)-2-propyl]benzene (bisphenol M), 2,2-bis(3,5-dimethyl-4-hydroxyphenyl)propane, 1,1-bis(4-hydroxyphenyl)-1-phenylethane, 2,2-bis(3,5-dichloro-4-hydroxyphenyl)propane and 2,2-bis(3,5-dibromo-4-hydroxyphenyl)propane.

Very particular preference is given to compounds of general formula (3b),

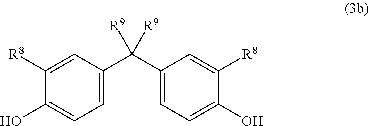

in which R⁸ represents H, linear or branched C₁-C₁₀-alkyl, preferably linear or branched C₁-C₆-alkyl, particularly preferably linear or branched C₁-C₄-alkyl, very particularly preferably H or C₁-alkyl (methyl), and
in which R⁹ represents linear or branched C₁-C₁₀-alkyl, preferably linear or branched C₁-C₆-alkyl, particularly preferably linear or branched C₁-C₄-alkyl, very particularly preferably C₁-alkyl (methyl).

Diphenol (3c) in particular is very particularly preferred here.

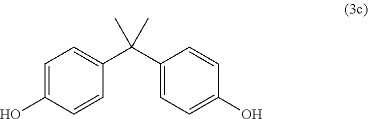 [SMILES: CC(C)(c1ccc(O)cc1)c1ccc(O)cc1]

The diphenols of general formulae (3a) may be used either alone or else in admixture with one another. The diphenols are known from the literature or producible by literature methods (see for example H. J. Buysch et al., Ullmann's Encyclopedia of Industrial Chemistry, VCH, New York 1991, 5th Ed., Vol. 19, p. 348).

The total proportion of the monomer units of formulae (1a), (1b), (1c) and (1d) in the copolycarbonate is preferably 0.1-88 mol %, particularly preferably 1-86 mol %, very particularly preferably 5-84 mol % and in particular 10-82 mol % (based on the sum of the moles of diphenols employed).

In a preferred embodiment of the composition according to the invention the diphenoxide units of the copolycarbonates of component A are derived from monomers having the general structures of the above-described formulae (1a′) and (3a).

In another preferred embodiment of the composition according to the invention the diphenoxide units of the copolycarbonates of component A are derived from monomers having the general structures of the above-described formulae (3a) and (1b′), (1c′) and/or (1d′).

The copolycarbonate component of the copolycarbonate compositions may be present as block and random copolycarbonate. Random copolycarbonates are particularly preferred.

The ratio of the frequency of the diphenoxide monomer units in the copolycarbonate is calculated from the molar ratio of the diphenols employed.

The optionally present homo- or copolycarbonate of component A comprises monomer unit(s) of general formula (2). Said units are introduced via a diphenol of general formula (2a):

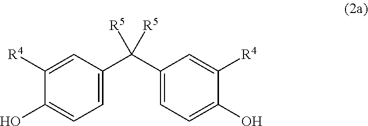

in which R⁴ represents H, linear or branched C₁-C₁₀-alkyl, preferably linear or branched C₁-C₆-alkyl, particularly preferably linear or branched C₁-C₄-alkyl, very particularly preferably H or C₁-alkyl (methyl) and
in which R⁵ represents linear or branched C₁-C₁₀-alkyl, preferably linear or branched C₁-C₆-alkyl, particularly preferably linear or branched C₁-C₄-alkyl, very particularly preferably C ₁-alkyl (methyl).

Diphenol (3c) in particular is very particularly preferred here.

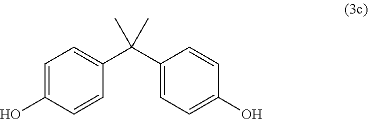 [SMILES: CC(C)(c1ccc(O)cc1)c1ccc(O)cc1]

In addition to one or more monomer units of general formulae (2) one or more monomer units of formula (3) as described above for component A may be present.

Provided that a blend is present as component A, said blend preferably comprises a homo-polycarbonate based on bisphenol A.

Production Process

Preferred methods of production of the homo- or copolycarbonates (also referred to hereinbelow as (co)polycarbonates) preferably employed in the composition according to the invention as component A, including the (co)polyestercarbonates, are the interfacial method and the melt transesterification process.

To obtain high molecular weight (co)polycarbonates by the interfacial method, the alkali salts of diphenols are reacted with phosgene in a biphasic mixture. The molecular weight may be controlled by the amount of monophenols which act as chain terminators, for example phenol, tert-butylphenol or cumylphenol, particularly preferably phenol, tert-butylphenol. These reactions form practically exclusively linear polymers. This may be confirmed by end-group analysis. Through deliberate use of so-called branching agents, generally polyhydroxylated compounds, branched polycarbonates are also obtained.

Employable as branching agents are small amounts, preferably amounts between 0.05 and 5 mol %, particularly preferably 0.1-3 mol %, very particularly preferably 0.1-2 mol %, based on the moles of diphenols employed, of trifunctional compounds such as, for example, isatin biscresol (IBC) or phloroglucin, 4,6-dimethyl-2,4,6-tri(4-hydroxyphenyl)hept-2-ene; 4,6-dimethyl-2,4,6-tri(4-hydroxyphenyl)heptane; 1,3,5-tri(4-hydroxyphenyl)benzene; 1,1,1-tri(4-hydroxyphenyl)ethane (THPE); tri(4-hydroxyphenyl)phenylmethane; 2,2-bis[4,4-bis(4-hydroxyphenyl)cyclohexyl]-propane; 2,4-bis(4-hydroxyphenylisopropyl)phenol; 2,6-bis(2-hydroxy-5′-methylbenzyl)-4-methylphenol; 2-(4-hydroxyphenyl)-2-(2,4-dihydroxyphenyl)propane; hexa(4-(4-hydroxyphenyl-isopropyl)phenyl) orthoterephthalate; tetra(4-hydroxyphenyl)methane; tetra (4-(4-hydroxyphenyl-isopropyl)phenoxy)methane; αα′α″-tris(4-hydroxyphenyl)-1,3,5-triisopropylbenzene; 2,4-dihydroxybenzoic acid; trimesic acid; cyanuric chloride; 3,3-bis(3-methyl-4-hydroxyphenyl)-2-oxo-2,3-dihydroindole; 1,4-bis(4′,4″-dihydroxytriphenyl)methyl)-benzene and in particular 1,1,1-tri(4-hydroxyphenyl)ethane (THPE) and bis(3-methyl-4-hydroxyphenyl)-2-oxo-2,3-dihydroindole. Preference is given to using isatin biscresol and also 1,1,1-tri(4-hydroxyphenyl)ethane (THPE) and bis(3-methyl-4-hydroxyphenyl)-2-oxo-2,3-dihydroindole as branching agents.

The use of these branching agents results in branched structures. The resulting long-chain branching normally leads to rheological properties of the obtained polycarbonates which manifests in a structural viscosity compared to linear types.

The amount of chain terminator to be employed is preferably 0.5 mol % to 10 mol %, preferably 1 mol % to 8 mol %, particularly preferably 2 mol % to 6 mol %, based on the moles of diphenols employed in each case. The addition of the chain terminators may be effected before, during or after the phosgenation, preferably as a solution in a solvent mixture of methylene chloride and chlorobenzene (8-15 wt %).

To obtain high molecular weight (co)polycarbonates by the melt transesterification process, diphenols are reacted in the melt with carbonic diesters, normally diphenyl carbonate, in the presence of catalysts, such as alkali metal salts, ammonium or phosphonium compounds.

The melt transesterification process is described for example in Encyclopedia of Polymer Science, Vol. 10 (1969), Chemistry and Physics of Polycarbonates, Polymer Reviews, H. Schnell, Vol. 9, John Wiley and Sons, Inc. (1964) and in DE-C 10 31 512.

In the melt transesterification process, diphenols of formulae (2a) and optionally (1a) are transesterified in the melt with carbonic diesters using suitable catalysts and optionally further added substances.

Carbonic diesters for the purposes of the invention are those of formulae (4) and (5)

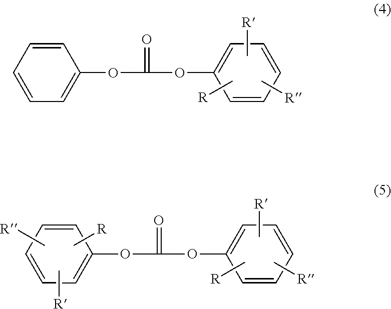

wherein
R,R′ and R″ may independently of one another represent H, optionally branched C ₁-C₃₄-alkyl/cycloalkyl, C₇-C₃₄-alkaryl or C₆-C₃₄-aryl,

for example diphenyl carbonate, butylphenyl phenyl carbonate, di(butylphenyl) carbonate, isobutylphenyl phenyl carbonate, di(isobutylphenyl) carbonate, tert-butylphenyl phenyl carbonate, di(tert-butylphenyl) carbonate, n-pentylphenyl phenyl carbonate, di(n-pentylphenyl) carbonate, n-hexylphenyl phenyl carbonate, di(n-hexylphenyl) carbonate, cyclohexylphenyl phenyl carbonate, di(cyclohexylphenyl) carbonate, phenylphenol phenyl carbonate, di(phenylphenol) carbonate, isooctylphenyl phenyl carbonate, di(isooctylphenyl) carbonate, n-nonylphenyl phenyl carbonate, di(n-nonylphenyl) carbonate, cumylphenyl phenyl carbonate, di(cumylphenyl) carbonate, naphthylphenyl phenyl carbonate, di(naphthylphenyl) carbonate, di-tert-butylphenyl phenyl carbonate, di(di-tert-butylphenyl) carbonate, dicumylphenyl phenyl carbonate, di(dicumylphenyl) carbonate, 4-phenoxyphenyl phenyl carbonate, di(4-phenoxyphenyl) carbonate, 3-pentadecylphenyl phenyl carbonate, di(3-pentadecylphenyl) carbonate, tritylphenyl phenyl carbonate, di(tritylphenyl) carbonate,

preferably diphenyl carbonate, tert-butylphenyl phenyl carbonate, di-(tert-butylphenyl) carbonate, phenylphenol phenyl carbonate, di(phenylphenol) carbonate, cumylphenyl phenyl carbonate, di(cumylphenyl) carbonate, particularly preferably diphenyl carbonate.

Mixtures of the recited carbonic diesters may also be employed.

The proportion of carbonic esters is 100 to 130 mol %, preferably 103 to 120 mol %, particularly preferably 103 to 109 mol %, based on the one or more diphenols.

As described in the recited literature basic catalysts such as alkali metal and alkaline earth metal hydroxides and oxides but also ammonium or phosphonium salts referred to hereinbelow as onium salts are employed as catalysts in the melt transesterification process. Preference is given to employing onium salts, particularly preferably phosphonium salts. For the purposes of the invention phosphonium salts are those having the following general formula (6)

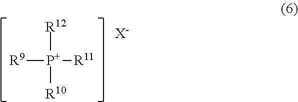

wherein
R⁹⁻¹² may be identical or different C₁-C₁₀-alkyls, C₆-C₁₀-aryls, C₇-C₁₀-aralkyls or C₅-C₆-cycloalkyls, preferably methyl or C₆-C₁₄-aryls, particularly preferably methyl or phenyl, and

X′ may be an anion such as hydroxide, sulfate, hydrogensulfate, hydrogencarbonate, carbonate, a halide, preferably chloride, or an alkoxide of formula OR^{I7}, wherein R¹⁷ may be C₆-C₁₄-aryl or C₇-C₁₂-aralkyl, preferably phenyl.

Preferred catalysts are tetraphenylphosphonium chloride, tetraphenylphosphonium hydroxide, tetraphenylphosphonium phenoxide, particularly preferably tetraphenylphosphonium phenoxide.

The catalyst is preferably employed in amounts of 10⁻⁸ to 10⁻³ mol, based on one mole of diphenol, particularly preferably in amounts of 10⁻⁷ to 10⁻⁴ mol,

Further catalysts may be employed alone or optionally in addition to the onium salt to in-crease the rate of the polymerization. These include salts of alkali metals and alkaline earth metals, such as hydroxides, alkoxides and aryloxides of lithium, sodium and potassium, preferably hydroxide, alkoxide or aryloxide salts of sodium. Greatest preference is given to sodium hydroxide and sodium phenoxide. The amounts of the cocatalyst may be in the range from 1 to 200 ppb, preferably 5 to 150 ppb and most preferably 10 to 125 ppb in each case reckoned as sodium.

The addition of the catalysts is effected in solution in order to avoid deleterious overconcentrations during metering. The solvents are system- and process-inherent compounds, for example diphenol, carbonic diesters or monohydroxyaryl compounds. Particular preference is given to monohydroxyaryl compounds because it is familiar to one skilled in the art that the diphenols and carbonic dieesters readily undergo transformation and decomposition even at only mildly elevated temperatures, in particular under the action of catalysts. This negatively affects polycarbonate qualities. In the industrially most important transesterification process for producing polycarbonate the preferred compound is phenol. Phenol is also a compelling option because during production the preferably employed tetraphenylphosphonium phenoxide catalyst is isolated as a cocrystal with phenol.

The process for producing the (co)polycarbonates present in the composition according to the invention by the transesterification process may be discontinuous or else continuous. Once the diphenols of formulae (2a) and optionally (1a) and carbonic diesters are present as a melt, optionally with further compounds, the reaction is initiated in the presence of the catalyst. The conversion/the molecular weight is increased with rising temperatures and falling pressures in suitable apparatuses and devices by removing the eliminated monohydroxyaryl compound until the desired final state is achieved. Choice of the ratio of diphenol to carbonic diester and of the rate of loss of the carbonic diester via the vapors and of any added compounds, for example of a higher-boiling monohydroxyaryl compound, said rate of loss arising through choice of procedure/plant for producing the polycarbonate, is what decides the end groups in terms of their nature and concentration.

With regard to the manner in which, the plant in which and the procedure by which the process is executed, there is no limitation or restriction.

Moreover, there is no specific limitation and restriction with regard to the temperatures, the pressures and catalysts used, in order to perform the melt transesterification reaction between the diphenol and the carbonic diester, and any other reactants added. Any conditions are possible, provided that the temperatures, pressures and catalysts chosen enable a melt transesterification with correspondingly rapid removal of the eliminated monohydroxyaryl compound.

The temperatures over the entire process are generally 180 to 330° C. at pressures of 15 bar absolute to 0.01 mbar absolute.

It is normally a continuous procedure that is chosen, because this is advantageous for product quality.

Preferably, the continuous process for producing polycarbonates is characterized in that one or more diphenols with the carbonic diester, also any other reactants added, using the catalysts, after pre-condensation, without removing the monohydroxyaryl compound formed, in several reaction evaporator stages which then follow at temperatures rising stepwise and pressures falling stepwise, the molecular weight is built up to the desired level.

The devices, apparatuses and reactors that are suitable for the individual reaction evaporator stages are, in accordance with the process sequence, heat exchangers, flash apparatuses, separators, columns, evaporators, stirred vessels and reactors or other purchasable apparatuses which provide the necessary residence time at selected temperatures and pressures. The devices chosen must enable the necessary input of heat and be constructed such that they are able to cope with the continuously increasing melt viscosities.

All devices are connected to one another by pumps, pipelines and valves. The pipelines between all the devices should of course be as short as possible and the curvature of the conduits should be kept as low as possible in order to avoid unnecessarily prolonged residence times. At the same time, the external, i.e. technical, boundary conditions and requirements for assemblies of chemical plants should be observed.

To perform the process by a preferred continuous procedure the coreactants can either be melted together or else the solid diphenol can be dissolved in the carbonic diester melt or the solid carbonic diester can be dissolved in the melt of the diphenol or both raw materials are combined in molten form, preferably directly from production. The residence times of the separate melts of the raw materials, in particular the residence time of the melt of the diphenol, are adjusted so as to be as short as possible. The melt mixture, by contrast, because of the depressed melting point of the raw material mixture compared to the individual raw materials, can reside for longer periods at correspondingly lower temperatures without loss of quality.

Thereafter, the catalyst, preferably dissolved in phenol, is mixed in and the melt is heated to the reaction temperature. At the start of the industrially important process for producing polycarbonate from 2,2-bis(4-hydroxyphenyl)propane and diphenyl carbonate, this temperature is 180 to 220° C., preferably 190 to 210° C., very particularly preferably 190° C. Over the course of residence times of 15 to 90 min, preferably 30 to 60 min, the reaction equilibrium is established without withdrawing the hydroxyaryl compound formed. The reaction can be run at atmospheric pressure, but for industrial reasons also at elevated pressure. The preferred pressure in industrial plants is 2 to 15 bar absolute.

The melt mixture is expanded into a first vacuum chamber, the pressure of which is set to 100 to 400 mbar, preferably to 150 to 300 mbar, and then heated directly back to the inlet temperature at the same pressure in a suitable device. In the expansion operation, the hydroxyaryl compound formed is evaporated together with monomers still present. After a residence time of 5 to 30 min in a bottoms reservoir, optionally with pumped circulation, at the same pressure and the same temperature, the reaction mixture is expanded into a second vacuum chamber, the pressure of which is 50 to 200 mbar, preferably 80 to 150 mbar, and directly afterwards heated in a suitable apparatus at the same pressure to a temperature of 190° C. to 250° C., preferably 210° C. to 240° C., particularly preferably 210° C. to 230° C. Here too, the hydroxyaryl compound thrilled is evaporated together with monomers still present. After a residence time of 5 to 30 min in a bottoms reservoir, optionally with pumped circulation, at the same pressure and the same temperature, the reaction mixture is expanded into a third vacuum chamber, the pressure of which is 30 to 150 mbar, preferably 50 to 120 mbar, and directly afterwards heated in a suitable apparatus at the same pressure to a temperature of 220° C. to 280° C., preferably 240° C. to 270° C., particularly preferably 240° C. to 260° C. Here too, the hydroxyaryl compound formed is evaporated together with monomers still present. After a residence time of 5 to 20 min in a bottoms reservoir, optionally with pumped circulation, at the same pressure and the same temperature, the reaction mixture is expanded into a further vacuum chamber, the pressure of which is 5 to 100 mbar, preferably 15 to 100 mbar, particularly preferably 20 to 80 mbar, and directly afterwards heated in a suitable apparatus at the same pressure to a temperature of 250° C. to 300° C., preferably 260° C. to 290° C., particularly preferably 260 to 280° C. Here too, the hydroxyaryl compound formed is evaporated together with monomers still present.

The number of these stages, 4 here by way of example, may vary between 2 and 6. The temperatures and pressures should be adjusted appropriately when the number of stages is altered in order to obtain comparable results. The relative viscosity of the oligomeric carbonate attained in these stages is between 1.04 and 1.20, preferably between 1.05 and 1.15, particularly preferably between 1.06 to 1.10.

The oligocarbonate thus obtained, after a residence time of 5 to 20 min in a bottoms reservoir, optionally with pumped circulation, at the same pressure and the same temperature as in the last flash/evaporator stage, is conveyed into a disk or cage reactor and subjected to further condensation at 250° C. to 310° C., preferably 250° C. to 290° C., more preferably 250° C. to 280° C., at pressures of 1 to 15 mbar, preferably 2 to 10 mbar, with residence times of 30 to 90 min, preferably 30 to 60 min. The product attains a relative viscosity of 1.12 to 1.28, preferably 1.13 to 1.26, particularly preferably 1.13 to 1.24.

The melt leaving this reactor is brought to the desired final viscosity/the final molecular weight in a further disk or cage reactor. The temperatures are 270° C. to 330° C., preferably 280° C. to 320° C., particularly preferably 280° C. to 310° C., and the pressure is 0.01 to 3 mbar, preferably 0.2 to 2 mbar, with residence times of 60 to 180 min, preferably 75 to 150 min. The relative viscosities are set to the level necessary for the application envisaged and are 1.18 to 1.40, preferably 1.18 to 1.36, particularly preferably 1.18 to 1.34.

The function of the two cage reactors or disk reactors can also be combined in one cage reactor or disk reactor.

The vapors from all the process stages are directly led off, collected and processed. This processing is generally effected by distillation in order to achieve high purities of the substances recovered. This can be effected, for example, according to German patent application no. 10 100 404. Recovery and isolation of the eliminated monohydroxyaryl compound in ultrapure form is an obvious aim from an economic and environmental point of view.

The monohydroxyaryl compound can be used directly for producing a diphenol or a carbonic diester.

It is a feature of the disk or cage reactors that they provide a very large, constantly renewing surface under reduced pressure with high residence times. The disk or cage reactors have a geometric shape in accordance with the melt viscosities of the products. Suitable examples are reactors as described in DE 44 47 422 C2 and EP A 1 253 163 or twin shaft reactors as described in WO A 99/28 370.

The oligocarbonates, including those of very low molecular weight, and the finished polycarbonates are generally conveyed by means of gear pumps, screws of a wide variety of designs or positive displacement pumps of a specific design.

Analogously to the interfacial method, it is possible to use polyfunctional compounds as branching agents.

The relative solution viscosity of the poly- or copolycarbonates present in the composition of the invention, determined according to DIN 51562, is preferably in the range of 1.15-1.35.

The weight-average molecular weights of homo- or copolycarbonates present in the composition according to the invention are preferably 15 000 to 40 000 g/mol, particularly preferably 17 000 to 36 000 g/mol, and very particularly preferably 17 000 to 34 000 g/mol, and are determined by GPC against a polycarbonate calibration.

Particular preference is given to copolycarbonate compositions in which the copolycarbonate of component A and/or the optionally also present further homo- or copolycarbonate of component A at least partly comprise as an end group a structural unit derived from phenol and/or a structural unit derived from 4-tert-butylphenol.

Component B

The compositions according to the invention comprise as component B at least one oxidized acid-modified polyethylene wax.

The employed special oxidized acid-modified polyethylene waxes preferably have an oxidation index (OI) of greater than 8, the oxidation index OI being ascertained by IR spectroscopy. The determination is effected by establishing the ratio of the area of the peak between 1750 cm⁻¹ and 1680 cm⁻¹ (carbonyl, C═O area) to the area of the peak between 1400 cm⁻¹ and 1330 cm⁻¹ (aliphatics CHₓaliphatics area). The calculation is as follows: OI═C═O area/aliphatics area*100. The determination may be effected with a commercially available FT IR spectrometer, for example Nicolet 5700 or Thermo Fisher Scientific 20DX FT IR instrument.

The employed special oxidized acid-modified polyethylene waxes (also referred to hereinbelow as “PE waxes”) are PE waxes typically produced by direct polymerization of ethylene by the Ziegler process. In a subsequent reaction step an air oxidation is effected which results in modified types. These special oxidized types have a content of acid modifications. The polyethylene waxes are available in particular from Mitsui under the brand “Hi-WAX”, acid-modified types. The acid numbers are preferably between 0.5 and 20 mg KOH/g. Preference is given to employing types having acid numbers of <10 mg KOH/g (JIS K0070 test method). The molecular weights (Mₙ) of these oxidized acid-modified polyethylene waxes are preferably between 1500 g/mol and 5000 g/mol. They preferably have a crystallinity of not less than 60% and not more than 90%. Their melting points are preferably in the range from greater than 90° C. and less than 130° C. The melt viscosities measured at 140° C., determined as per ISO 11443, are preferably between 70 mPas·s and 800 mPa·s.

The oxidized acid-modified polyethylene waxes are preferably supplied to the polycarbonate melt in situ in a continuous or batchwise polycarbonate production process via a side assembly directly or in the form of a masterbatch or in a compounding process directly or in the form of a masterbatch via a side assembly, preferably under air exclusion.

The oxidized acid-modified polyethylene waxes are employed in amounts of 0.05 to 10.0 wt %, preferably 0.08 to 6.0 wt %, more preferably 0.10 to 5.0 wt % and particularly preferably 0.15 to 4.5 wt %, and very particularly preferably of 0.15 to 4.0 wt %, based on the total weight of the composition.

Component C

The present invention further provides compositions comprising the components A and B and optionally as component C one or more additives and/or fillers in a total amount of up to 30 wt %.

Provided that additives and/or fillers are present these are preferably selected from the group consisting of carbon black, UV stabilizers, IR absorbers, thermal stabilizers, antistats and pigments, colorants in the customary amounts; it is optionally possible to improve demolding characteristics, flow characteristics and/or flame retardancy by adding external demolding agents, flow agents and/or flame retardants such as sulfonate salts, PTFE polymers/PTFE copolymers, brominated oligocarbonates, or oligophosphates and phosphazenes (e.g. alkyl and aryl phosphites, phosphates, phosphanes, low molecular weight carboxylic esters, halogen compounds, salts, chalk, talc, thermally or electrically conductive carbon blacks or graphites, quartz/quartz flour, glass and carbon fibers, pigments or else additives for reduction of the coefficient of linear thermal expansion (CLTE) and combination thereof. Such compounds are described for example in WO 99/55772, p. 15-25, and in “Plastics Additives”, R. Gächter and H. Müller, Hanser Publishers 1983).

The composition generally comprises 0 to 5.0 wt %, preferably 0 to 2.50 wt %, particularly preferably 0 to 1.60 wt %, very particularly preferably 0.03 to 1.50 wt %, especially particularly preferably 0.02 to 1.0 wt % (based on the overall composition) of organic additives.

The demoulding agents optionally added to the compositions according to the invention are preferably selected from the group consisting of pentaerythritol tetrastearate, glycerol monostearate and long-chain fatly acid esters, for example stearyl stearate and propanediol stearate, and mixtures thereof. The demolding agents are preferably used in amounts of 0.05 wt % to 2.00 wt %, preferably in amounts of 0.1 wt % to 1.0 wt %, more preferably in amounts of 0.15 wt % to 0.60 wt % and most preferably in amounts of 0.20 wt % to 0.50 wt % based on the the total weight of components A, B and C.

Suitable additives and fillers are described for example in “Additives for Plastics Handbook, John Murphy, Elsevier, Oxford 1999”, in “Plastics Additives Handbook, Hans Zweifel, Hanser, Munich 2001”.

Suitable antioxidants/thermal stabilizers are for example:

alkylated monophenols, alkylthiomethylphenols, hydroquinones and alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, acylaminophenols, esters of β-(3,5-di-tert-butyl-4-hydroxyphenyl)propionic acid, esters of β-(5tert-butyl-4-hydroxy-3-methyl-phenyl)propionic acid, esters of β-(3,5-dicyclohexyl-4-hydroxyphenyl)propionic acid, esters of 3,5-di-tert-butyl-4-hydroxyphenylacetic acid, amides of β-(3,5-di-tert-butyl-4-hydroxyphenyl)propionic acid, suitable thio synergists, secondary antioxidants, phosphites and phosphonites, benzofuranones and indolinones.

Preferentially suitable thermal stabilizers are tris(2,4-di-tert-butylphenyl) phosphite (Irgafos® 168), tetrakis(2,4-di-tert-butylphenyl)-[1-biphenyl]-4,4′-diyl bisphosphonite, triisoctyl phosphate (TOF), octadecyl-3-(3,5-di-tert-butyl-4-hydroxyphenyl) propionate (Irganox® 1076), bis(2,4-dicumylphenyl)pentaerythritol diphosphite (Doverphos® S-9228), bis(2,6-di-tert-butyl-4-methylphenyl)pentaerythritol diphosphite (ADK STAB PEP-36) and triphenylphosphine (TPP). Said thermal stabilizers are used alone or in admixture (e.g. Irganox B900 or Doverphos S-9228 with Irganox B900/Irganox 1076 or triphenylphosphine (TPP) with triisoctyl phosphate (TOF)). Thermal stabilizers are preferably used in amounts of 0.005 wt % to 2.00 wt %, preferably in amounts of 0.01 wt % to 1.0 wt %, more preferably in amounts of 0.015 wt % to 0.60 wt % and most preferably in amounts of 0.02 wt % to 0.50 wt %, based on the the total weight of components A, B and C.

Suitable complexing agents for heavy metals and neutralization of traces of alkalis are o/m-phosphoric acids, fully or partly esterified phosphates or phosphites.

Suitable light stabilizers (UV absorbers) are 2-(2′-hydroxyphenyl)benzotriazoles. 2-hydroxybenzophenones, esters of substituted and unsubstituted benzoic acids, acrylates, sterically hindered amines, oxamides and 2-(hydroxyphenyl)-1,3,5-triazines/substituted hydroxyalkoxyphenyl, 1,3,5-triazoles, preference being given to substituted benzotriazoles, for example 2-(2′-hydroxy-5′-methylphenyl)benzotriazole, 2-(2′-hydroxy-3′,5′-di-t-butylphenyl)benzotriazole, 2-(2′-hydroxy-3′-tert-butyl-5′-methylphenyl)-5-chlorobenzotriazole, 2-(2′-hydroxy-3′,5′-tert-butylphenyl)-5-chlorobenzotriazole, 2-(2′-hydroxy-5′-tert-octylphenyl)benzotriazole, 2-(2′-hydroxy-3′,5′-di-tert-amylphenyl)benzotriazole, 2-[2′-hydroxy-3′(3″,4″,5″,6″-tetrahydroplithalimidoethyl)-5′-methylphenyl]benzotriazole and 2,2′-methylenebis[4-(1,1,3,3-tetramethylbutyl)-6-(2H-benzotriazol-2-yl)phenol].

Further suitable UV stabilizers are selected from the group comprising benzotriazoles (e.g. Tinuvins from BASF), triazine Tinuvin 1600 from BASF), benzophenones (Uvinuls from BASF), cyanoacrylates (Uvinuls from BASF), cinnamic esters and oxalanilides, and mixtures of these UV stabilizers.

The UV stabilizers are used in amounts of 0.01 wt % to 2.0 wt % based on the molding material, preferably in amounts of 0.05 wt % to 1.00 wt %, more preferably in amounts of 0.08 wt % to 0.5 wt % and most preferably in amounts of 0.1 wt % to 0.4 wt % based on the overall composition.

Polypropylene glycols, alone or in combination with, for example, sulfones or sulfonamides as stabilizers, can be used to counteract damage by gamma rays.

These and other stabilizers can be used individually or in combination and can be added to the polymer in the recited forms.

Suitable flame-retardant additives are phosphate esters, i.e. triphenyl phosphate, resorcinol diphosphate, brominated compounds, such as brominated phosphoric esters, brominated oligocarbonates and polycarbonates, and preferably salts of fluorinated organic sulfonic acids.

Suitable impact modifiers are butadiene rubber with grafted-on styrene-acrylonitrile or methyl methacrylate, ethylene-propylene rubbers with grafted-on maleic anhydride, ethyl and butyl acrylate rubbers with grafted-on methyl methacrylate or styrene-acrylonitrile, interpenetrating siloxane and acrylate networks with grafted-on methyl methacrylate or styrene-acrylonitrile.

In addition, it is possible to add colorants such as organic dyes or pigments or inorganic pigments, carbon black, IR absorbers, individually, in a mixture or else in combination with stabilizers, glass fibers, (hollow) glass beads, inorganic fillers, for example titanium dioxide, talc, silicates or barium sulfate.

In a particularly preferred embodiment the composition according to the invention comprises at least one additive selected from the group consisting of thermal stabilizers, demolding agents and UV absorbers, preferably in a total amount of 0.01 wt % to 2.0 wt % based on the total amount of components A, B and C. Particular preference is given to thermal stabilizers.

In a preferred embodiment the composition according to the invention comprises at least one inorganic filler.

In a further preferred embodiment the composition according to the invention comprises 0.002 to 0.2 wt % of thermal stabilizer, 0.01 wt % to 1.00 wt % of UV stabilizer and 0.05 wt % to 2.00 wt % of demolding agent.

The copolycarbonate compositions according to the invention are produced in customary machines, for example multishaft extruders, by compounding optionally with addition of additives and other added materials at temperatures between 280° C. and 360° C.

The copolycarbonate compositions according to the invention can be processed in a customary manner in standard machines, for example in extruders or injection molding machines, to give any shaped articles/moldings, to give films or sheets or bottles.

The copolycarbonate compositions according to the invention, optionally in a blend with other thermoplastics and/or customary additives, can be used to give any desired shaped articles/extrudates, wherever already known polycarbonates, polyestercarbonates and polyesters are used:
1. Safety glazing which, as is well known, is required in many regions of buildings, vehicles and aircraft, and as shields of helmets.
2. Production of films and film laminates.
3. Automobile headlights, bezels, indicators, reflectors (components having reduced coefficients of thermal expansion)
4. As translucent plastics having a content of glass fibers for lighting purposes. As translucent plastics having a content of barium sulfate, titanium dioxide and/or zirconium oxide or high-reflectance opaque compositions and components produced therefrom.
5. For production of precision injection moldings, for example lenses, collimators, lens holders, light guide elements and LED applications.
6. As electrical insulators for electrical conductors and for plug housings and plug connectors.
7. Housings for electrical appliances.
8. Protective glasses, eyepieces.
9. For medical applications, medical devices, for example oxygenators, dialyzers (hollow fiber dialyzers), 3-way taps, hose connectors, blood filters, injection systems, inhalers, ampoules.
10, Extruded shaped articles such as sheets and films.
11. LED applications (sockets, reflectors, heat sinks).
12. As a feedstock for compounds or as a blend partner or component in blend compositions and components produced therefrom.

This application likewise provides the compounds, blends, shaped articles, extrudates, films and film laminates made from the copolycarbonate compositions according to the invention, and likewise moldings, extrudates and films comprising coextrusion layers made from the copolycarbonate compositions according to the invention.

It is a particular feature of the compositions according to the invention that they exhibit exceptional flow properties on account of their content of oxidized acid-modified polyethylene wax.

The present invention accordingly also provides for the use of one or more of the oxidized acid-modified polyethylene waxes described hereinabove for improving the flowability of compositions comprising a copolycarbonate or a blend of the copolycarbonate and a further homo- or copolycarbonate (component A) and optionally one or more added substances (component C).

The examples which follow are intended to illustrate the invention but without limiting said invention.

### EXAMPLES

Raw Materials Used:
Component A is a blend of PC1 and PC2 (examples 1-4), copolycarbonate PC3 or PC4(examples 5 to 12) or one of copolycarbonates PC5 to PC11 (see table 7, examples 13-40).
PC 1 is a commercially available copolycarbonate based on bisphenol A and bisphenol TMC having an MVR of 18 cm³/10 min (330° C./2.16 kg) and a softening temperature (VST/B 120) of 183° C. (Apec 1895 from Bayer MaterialScience AG).
PC 2 is a polycarbonate powder based on bisphenol A having an MVR of 6 cm³/10 min (300° C./1.2 kg). It serves to improve incorporation (metering) of the PE wax.
PC 3 Lexan XHT2141; high heat copolycarbonate based on bisphenol A and the bisphenol of formula)(Ib′) where R³ =phenyl from Sabic Innovative Plastics having an MVR of 43 cm³/10 min (330° C., 2.16 kg)
PC 4 Lexan XHT4143; UV stabilized high heat copolycarbonate based on bisphenol A and the bisphenol of formula (Ib′) where R³ phenyl from Sabic Innovative Plastics
Component B (PE wax): Oxidized acid-modified polyethylene wax having a molecular weight of 4000 g/mol, an acid number of 1 mg KOH/g, a degree of crystallization of 80% and a melting point (DSC) of 121° C. and also a melt viscosity (at 140° C.) of 650 mPa*s. Hi-Wax 405MP from Mitsui Chemicals Inc. was used. The oxidation index OI as determined by IR spectroscopy was 55.4. The determination was effected with a commercially available FT IR spectrometer, for example Nicolet 5700 or Thermo Fisher Scientific 20DX FT IR instrument. The ratio of the area of the peak between 1750 cm⁻¹ and 1680 cm⁻¹ (carbonyl) to the area of the peak between 1400 cm⁻¹ and 1330 cm⁻¹ (aliphatics CHx) was established. The calculation was as follows: C═O area/aliphatics area*100.

### Synthesis of the bisphenol of Formula (Ib′) where R³=methyl:

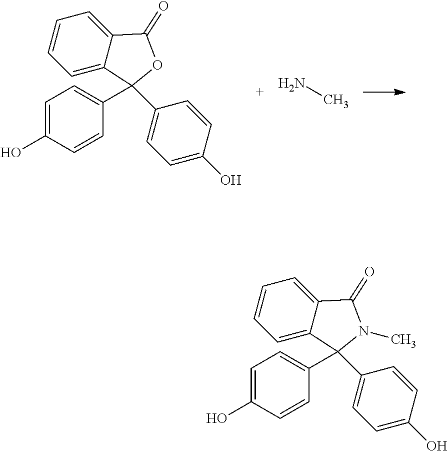

A flange reactor is initially charged with a solution of 2 kg (20.2 mol) of N-methylpyrrolidone (NMP) and 1273.3 g (4 mol) of phenolphthalein. 2 liters of water and then 18 mol of a 40% aqueous methylamine solution are added with stirring. The reaction solution turns violet upon addition of the methylamine. The mixture is then stirred for a further 8 hours at 82° C. utilizing a dry ice cooler. This causes the coloring of the reaction batch to change to dark yellowish. Once the reaction has ended the reaction batch is precipitated by means of a dropping funnel with stirring into a reservoir of water acidified with hydrochloric acid.

The precipitated white reaction product is slurried with 2 liters of water and then suctioned off using a G3 frit. The crude product obtained is redissolved in 3.5 liters of a dilute sodium hydroxide solution (16 mol) and in turn precipitated in a reservoir of water acidified with hydrochloric acid. The reprecipitated crude product is repeatedly slurried with 2 liters of water and then suctioned off each time. This washing procedure is repeated until the conductivity of the washing water is less than 15 μS.

The thus obtained product is dried to constant mass in a vacuum drying cabinet at 90° C.,

After 4-fold performance of the experiment the following yields were obtained in each case:
1a) 950 g of a white solid
1b) 890 g of a white solid
1c) 1120 g of a white solid
1d) 1050 g of a white solid
(melting point 264° C.)

Characterization of the obtained bisphenol was effected by ¹H-NMR spectroscopy.

### Synthesis of copolycarbonate based on a bisphenol of formula (1b′) where R³=methyl and bisphenol A:

To a nitrogen-inertized solution of 532.01 g (1.6055 mol) of bisphenol A (BPA), 2601.36 g (11.39 mol) of bisphenol from example 1, 93.74 g (0.624 mol, 4.8 mol % based on diphenols) of p-tert-butylphenol (BUP) as chain terminator and 1196 g (29.9 mol) sodium hydroxide in 25.9 liters of water are added 11.79 liters of methylene chloride and 14.1 liters of chlorobenzene. At a pH of 12.5-13.5 and 20° C., 2.057 kg (20.8 mol) of phosgene are introduced. In order to prevent the pH from falling below 12.5, 30% sodium hydroxide was added during the phosgenation. Once phosgenation is complete and after purging with nitrogen the mixture is stirred for a further 30 minutes, 14.7 g (0.13 mol, 1 mol % based on diphenols) of N-ethylpiperidine are added as catalyst and the mixture is stirred for a further 1 hour. After removal of the aqueous phase and acidification with phosphoric acid the organic phase is washed several times with water using a separator until salt-free. The organic phase is separated off and subjected to a solvent exchange in which methylene chloride is replaced with chlorobenzene. The concentrated copolycarbonate solution in chlorobenzene is then freed of solvent using a vented extruder. The obtained polycarbonate melt extrudates are cooled in a water bath, drawn off and finally palletized. Transparent polycarbonate pellets are obtained.

### Synthesis of copolycarbonates PC5 to PC11

Copolycarbonates PC-5 to PC-11 were produced as per the preceding procedure for producing copolycarbonate based on a bisphenol of formula (Ib′) where R³=methyl and bisphenol A (see table 7 for stoichiometry).

### Synthesis of the copolycarbonate Compositions of Examples 1-4

The copolycarbonate compositions of examples 1-4 based on raw materials PC1 and PC2 and also component B are mixed according to the formulations reported in table 1 in a twin-screw extruder at 300° C. The thus-obtained polymer compositions are pelletized and are ready for polymer-physical characterization.

### Synthesis of the copolycarbonate Compositions of Examples 1-4

The polycarbonate compositions of examples 5 to 40 are produced in a DSM Miniextruder based on the raw materials stated. The melt temperature was 330° C. The thus-obtained polymer compositions are pelletized and are ready for polymer physical characterization.

Characterization of the Molding Materials According to the Invention (Test Methods)

Characterization of the molding materials according to the invention (test methods): Melt volume flow rate (MVR) was determined in accordance with ISO 1133 (at a test temperature of 330° C., mass 2.16 kg) using a Zwick 4106 instrument from Roell.

Vicat softening temperature VST/B120 was determined as a measure of heat distortion resistance in accordance with ISO 306 on test specimens measuring 80 mm×10 mm×4 mm with a 50 N ram loading and a heating rate of 50° C./h or of 120° C./h with a Coesfeld Eco 2920 instrument from Coesfeld Materialtest.

Modulus of elasticity was measured according to ISO 527 on single side injection-molded shoulder bars having a core measuring 80×10×4 mm.

Spiral flow: Either a defined length is set or a defined pressure is specified. The test specimen geometry is 8×2 mm, the flow length is obtained from the test.

The comparative value is set to a defined flow length. The samples to be measured are characterized under identical conditions. Larger numerical values indicate improved flowability (longer flow length).

The rheological tests were performed with an MCR 301 cone-and-plate rheometer with a CP 25 measuring cone and the conditions reported below:
Test method: Oscillation—cone and plate
Frequency: 75 to 0.08 Hz=angular frequency of 471 to 0.5 [1/s]
Deformation: 10% -20 measurement points
Temperatures: 300° C., 280° C. and 260° C., +−0.3° C.

TABLE 1
Compositions and experimental data for examples 1-4

| | | Examples: | | | |
|---|---|---|---|---|---|
| | | 1 (comparison) | 2 | 3 | 4 |
| PC-1 | % | 93 | 93 | 93 | 93 |
| PC-2 | % | 7 | 5.5 | 4 | 2.5 |
| PE wax | % | | 1.5 | 3 | 4.5 |
| MVR | ml/10 min | 15.8 | 17.0 | 18.1 | 21.0 |
| 330° C./ | | | | | |
| 2.16 kg | | | | | |
| Vicat VSTB | ° C. | 181.4 | 180.0 | 178.9 | 178.4 |
| 120 | | | | | |
| Modulus of | N/mm² | 2524 | 2500 | 2454 | 2410 |
| elasticity | | | | | |
| Spiral flow | cm | 25* | 26.5 | 34 | 56 |

The % values are wt % values in each case.

It is clearly apparent that the MVR is significantly increased due to the addition of the PE wax, i.e. the melt viscosity is reduced and the flowability is thus increased. The Vicat temperature is only slightly reduced by addition of the PE wax but remains a high range even at large amount. The tensile modulus is only slightly reduced by addition of the PE wax but remains a high range even at large amount. It is apparent from the spiral flow values that addition of the oxidized polyethylene wax achieves a marked improvement in flowability.

TABLE 2
Melt viscosities of the compositions of examples 1-4
The values in the following table are each reported
together with the shear rates in [1/sec].

| | | Examples | | | |
|---|---|---|---|---|---|
| | | 1 (comparison) | 2 | 3 | 4 |
| Melt visc. at 300° C. | | | | | |
| eta 50 | Pa · s | 1683 | 948 | 617 | 410 |
| eta 100 | Pa · s | 1506 | 813 | 525 | 295 |
| eta 200 | Pa · s | 1268 | 676 | 447 | 219 |
| eta 500 | Pa · s | 851 | 537 | 332 | 139 |
| eta 1000 | Pa · s | 608 | 424 | 275 | 96 |
| eta 1500 | Pa · s | 483 | 376 | 234 | 82 |
| eta 5000 | Pa · s | 223 | 196 | 138 | 43 |
| Melt visc. at 320° C. | | | | | |
| eta 50 | Pa · s | 919 | 646 | 449 | 282 |
| eta 100 | Pa · s | 861 | 540 | 372 | 217 |
| eta 200 | Pa · s | 784 | 457 | 309 | 148 |
| eta 500 | Pa · s | 607 | 339 | 222 | 105 |
| eta 1000 | Pa · s | 440 | 262 | 176 | 72 |
| eta 1500 | Pa · s | 347 | 233 | 150 | 59 |
| eta 5000 | Pa · s | 157 | 139 | 81 | 33 |
| Melt visc. at 330° C. | | | | | |
| eta 50 | Pa · s | 604 | 490 | 331 | 257 |
| eta 100 | Pa · s | 593 | 437 | 288 | 180 |
| eta 200 | Pa · s | 556 | 368 | 229 | 135 |
| eta 500 | Pa · s | 457 | 281 | 180 | 96 |
| eta 1000 | Pa · s | 352 | 217 | 142 | 68 |
| eta 1500 | Pa · s | 286 | 186 | 118 | 54 |
| eta 5000 | Pa · s | 135 | 114 | 63 | 29 |
| Melt visc. at 340° C. | | | | | |
| eta 50 | Pa · s | 439 | 347 | 269 | 219 |
| eta 100 | Pa · s | 429 | 316 | 229 | 167 |
| eta 200 | Pa · s | 410 | 267 | 195 | 123 |
| eta 500 | Pa · s | 347 | 209 | 146 | 86 |
| eta 1000 | Pa · s | 280 | 168 | 117 | 65 |
| eta 1500 | Pa · s | 234 | 148 | 99 | 50 |
| eta 5000 | Pa · s | 116 | 93 | 53 | 26 |
| Melt visc. at 360° C. | | | | | |
| eta 50 | Pa · s | 215 | 198 | 190 | 135 |
| eta 100 | Pa · s | 214 | 186 | 170 | 107 |
| eta 200 | Pa · s | 213 | 166 | 140 | 80 |
| eta 500 | Pa · s | 193 | 127 | 105 | 56 |
| eta 1000 | Pa · s | 166 | 102 | 78 | 44 |
| eta 1500 | Pa · s | 148 | 91 | 67 | 36 |
| eta 5000 | Pa · s | 85 | 61 | 40 | 18 |

It is apparent from the melt viscosities that a marked improvement in flowability is achieved through addition of the oxidized polyethylene wax for all temperatures of the processing-relevant range and over all shear rates.

TABLE 3
Composition of the compounds of examples 5-12

| | | Example | | | | | | | |
|---|---|---|---|---|---|---|---|---|---|
| | | 5 (com- | | | | 9 (com- | | | |
| | | parison) | 6 | 7 | 8 | parison) | 10 | 11 | 12 |
| PC-3 | % | 100 | 99.5 | 99.0 | 98.0 | | | | |
| PC-4 | % | | | | | 100 | 99.5 | 99.0 | 98.0 |
| PE Wax | % | | 0.5 | 1.0 | 2.0 | | 0.5 | 1.0 | 2.0 |
| Tg | [° C.] | 164.1 | 165.0 | 164.9 | 164.7 | 183.9 | 183.4 | 183.8 | 184.3 |

The % values are wt % values in each case.

TABLE 4
Melt viscosity at angular frequency of 471 to 0.503 [Hz]

| | | Example | | | | | | | |
|---|---|---|---|---|---|---|---|---|---|
| Cone/plate | | 5 | | | | 9 | | | |
| rheology | | (comp.) | 6 | 7 | 8 | (comp.) | 10 | 11 | 12 |
| Melt visc. at | | | | | | | | | |
| 260° C. [Hz] | | | | | | | | | |
| 471 | Pa · s | 1260 | 1310 | 1310 | 1240 | 2080 | 2080 | 1940 | 1450 |
| 329 | Pa · s | 1520 | 1580 | 1570 | 1480 | 2570 | 2600 | 2430 | 1960 |
| 229 | Pa · s | 1780 | 1860 | 1840 | 1730 | 3120 | 3170 | 3030 | 2340 |
| 160 | Pa · s | 2050 | 2140 | 2120 | 1990 | 3720 | 3790 | 3680 | 2980 |
| 112 | Pa · s | 2320 | 2430 | 2410 | 2260 | 4370 | 4470 | 4400 | 3810 |
| 77.8 | Pa · s | 2580 | 2700 | 2680 | 2520 | 5160 | 5290 | 5250 | 4780 |
| 54.3 | Pa · s | 2830 | 2950 | 2940 | 2760 | 6030 | 6180 | 6180 | 5730 |
| 37.9 | Pa · s | 3050 | 3180 | 3170 | 2970 | 6930 | 7100 | 7160 | 6620 |
| 26.4 | Pa · s | 3230 | 3380 | 3360 | 3160 | 7850 | 8040 | 8160 | 7560 |
| 18.4 | Pa · s | 3390 | 3540 | 3530 | 3310 | 8770 | 8980 | 9180 | 8520 |
| 12.9 | Pa · s | 3510 | 3670 | 3660 | 3430 | 9670 | 9950 | 10200 | 9640 |
| 8.97 | Pa · s | 3600 | 3760 | 3760 | 3530 | 10600 | 10900 | 11200 | 10500 |
| 6.25 | Pa · s | 3660 | 3840 | 3840 | 3610 | 11500 | 11800 | 12100 | 11200 |
| 4.36 | Pa · s | 3710 | 3890 | 3900 | 3670 | 12300 | 12500 | 12900 | 11800 |
| 3.04 | Pa · s | 3750 | 3940 | 3950 | 3730 | 12900 | 13000 | 13400 | 12300 |
| 2.12 | Pa · s | 3770 | 3960 | 3990 | 3770 | 13300 | 13400 | 13800 | 12600 |
| 1.48 | Pa · s | 3790 | 3990 | 4020 | 3820 | 13600 | 13700 | 14200 | 12900 |
| 1.03 | Pa · s | 3800 | 4010 | 4050 | 3860 | 13800 | 13900 | 14400 | 13200 |
| 0.721 | Pa · s | 3810 | 4020 | 4070 | 3890 | 14000 | 14100 | 14700 | 13400 |
| 0.503 | Pa · s | 3810 | 4030 | 4080 | 3910 | 14100 | 14200 | 14800 | 13500 |
| Melt visc. at | | | | | | | | | |
| 280° C. [Hz] | | | | | | | | | |
| 471 | Pa · s | 570 | 621 | 613 | 594 | 815 | 934 | 840 | 866 |
| 329 | Pa · s | 695 | 710 | 696 | 675 | 1060 | 1130 | 1070 | 1090 |
| 229 | Pa · s | 800 | 794 | 776 | 751 | 1320 | 1340 | 1300 | 1310 |
| 160 | Pa · s | 892 | 871 | 850 | 823 | 1590 | 1560 | 1530 | 1540 |
| 112 | Pa · s | 967 | 940 | 917 | 887 | 1860 | 1770 | 1750 | 1760 |
| 77.8 | Pa · s | 1030 | 1000 | 975 | 943 | 2100 | 1980 | 1960 | 1970 |
| 54.3 | Pa · s | 1080 | 1050 | 1020 | 991 | 2310 | 2180 | 2140 | 2160 |
| 37.9 | Pa · s | 1130 | 1090 | 1060 | 1030 | 2490 | 2350 | 2300 | 2330 |
| 26.4 | Pa · s | 1160 | 1120 | 1090 | 1060 | 2650 | 2500 | 2440 | 2480 |
| 18.4 | Pa · s | 1180 | 1150 | 1120 | 1080 | 2790 | 2620 | 2560 | 2600 |
| 12.9 | Pa · s | 1200 | 1160 | 1130 | 1100 | 2890 | 2710 | 2650 | 2700 |
| 8.97 | Pa · s | 1210 | 1180 | 1150 | 1110 | 2970 | 2780 | 2720 | 2780 |
| 6.25 | Pa · s | 1220 | 1180 | 1160 | 1130 | 3030 | 2840 | 2770 | 2840 |
| 4.36 | Pa · s | 1220 | 1190 | 1170 | 1140 | 3070 | 2870 | 2810 | 2880 |
| 3.04 | Pa · s | 1230 | 1200 | 1180 | 1160 | 3090 | 2900 | 2850 | 2930 |
| 2.12 | Pa · s | 1230 | 1200 | 1180 | 1170 | 3110 | 2920 | 2870 | 2960 |
| 1.48 | Pa · s | 1230 | 1200 | 1190 | 1180 | 3120 | 2940 | 2890 | 3000 |
| 1.03 | Pa · s | 1230 | 1200 | 1190 | 1180 | 3120 | 2950 | 2910 | 3030 |
| 0.721 | Pa · s | 1230 | 1200 | 1200 | 1190 | 3120 | 2950 | 2920 | 3050 |
| 0.503 | Pa · s | 1230 | 1200 | 1190 | 1190 | 3120 | 2950 | 2910 | 3070 |
| Melt visc. at | | | | | | | | | |
| 300° C. [Hz] | | | | | | | | | |
| 471 | Pa · s | 366 | 334 | 344 | 327 | 558 | 545 | 510 | 526 |
| 329 | Pa · s | 399 | 362 | 374 | 355 | 648 | 625 | 577 | 599 |
| 229 | Pa · s | 430 | 387 | 401 | 380 | 731 | 698 | 641 | 668 |
| 160 | Pa · s | 457 | 408 | 424 | 401 | 804 | 765 | 700 | 730 |
| 112 | Pa · s | 479 | 426 | 442 | 418 | 868 | 825 | 752 | 785 |
| 77.8 | Pa · s | 496 | 439 | 457 | 431 | 923 | 876 | 796 | 832 |
| 54.3 | Pa · s | 510 | 449 | 469 | 441 | 967 | 918 | 832 | 869 |
| 37.9 | Pa · s | 520 | 457 | 478 | 449 | 1000 | 951 | 861 | 899 |
| 26.4 | Pa · s | 528 | 462 | 484 | 456 | 1030 | 977 | 882 | 922 |
| 18.4 | Pa · s | 533 | 466 | 490 | 461 | 1050 | 995 | 899 | 940 |
| 12.9 | Pa · s | 536 | 469 | 494 | 466 | 1060 | 1010 | 911 | 954 |
| 8.97 | Pa · s | 538 | 471 | 498 | 471 | 1070 | 1020 | 920 | 965 |
| 6.25 | Pa · s | 540 | 472 | 501 | 476 | 1070 | 1020 | 927 | 975 |
| 4.36 | Pa · s | 542 | 473 | 503 | 481 | 1070 | 1030 | 933 | 985 |
| 3.04 | Pa · s | 543 | 474 | 506 | 485 | 1080 | 1030 | 938 | 995 |
| 2.12 | Pa · s | 544 | 474 | 507 | 488 | 1080 | 1030 | 941 | 1000 |
| 1.48 | Pa · s | 545 | 475 | 509 | 491 | 1070 | 1030 | 943 | 1010 |
| 1.03 | Pa · s | 547 | 476 | 511 | 493 | 1070 | 1030 | 944 | 1010 |
| 0.721 | Pa · s | 549 | 477 | 514 | 495 | 1070 | 1030 | 944 | 1020 |
| 0.503 | Pa · s | 552 | 478 | 515 | 494 | 1070 | 1030 | 939 | 1010 |

Table 4 shows that compared to the inventive examples 6, 7, 8 and 10, 11, 12, the comparative examples 5 and 9 which do not comprise the flow assistant exhibit higher melt viscosities and thus have poorer flowability at the three measurement temperatures.

TABLE 5
Composition of the copolycarbonates PC-5 to PC-11

| Copolycarbonate no. | | | | | | | |
|---|---|---|---|---|---|---|---|
| based on: | PC-5 | PC-6 | PC-7 | PC-8 | PC-9 | PC-10 | PC-11 |
| Bisphenol according to | | | | | | | |
| formula (1b′) where | | | | | | | |
| R³ = methyl | | | | | | | |
| [mol %] | 77.93 | 78.5 | 77.5 | 76.5 | 80 | 80 | 80 |
| [wt %] | 70.9 | 71.6 | 70.4 | 69.2 | 73.4 | 73.4 | 73.4 |
| Bisphenol A (BPA) | | | | | | | |
| [mol %] | 22.07 | 21.5 | 22.5 | 23.5 | 20 | 20 | 20 |
| [wt %] | 29.1 | 28.4 | 29.6 | 30.8 | 26.6 | 26.6 | 26.6 |
| Glass transition temper- | | | | | | | |
| ature Tg [° C.] | 179.4 | 179.6 | 179.6 | 182.3 | 175.3 | 176.1 | 173.9 |
| ηᵣₑₗ | — | 1.234 | 1.225 | 1.237 | 1.216 | 1.228 | 1.218 |

TABLE 6
Composition of the compounds of examples 13-40

| | | | | | | | | PE | |
|---|---|---|---|---|---|---|---|---|---|
| | PC-9 | PC-10 | PC-11 | PC-6 | PC-7 | PC-8 | PC-5 | wax | Tg |
| Example | % | % | % | % | % | % | % | % | ° C. |
| 13 | 100 | | | | | | | | 176.7 |
| (comparative) | | | | | | | | | |
| 14 | 99.5 | | | | | | | 0.5 | 175.5 |
| 15 | 99.0 | | | | | | | 1 | 175.3 |
| 16 | 98.0 | | | | | | | 2 | 175.3 |
| 17 | | 100 | | | | | | | 177.1 |
| (comparative) | | | | | | | | | |
| 18 | | 99.5 | | | | | | 0.5 | 176.2 |
| 19 | | 99.0 | | | | | | 1 | 174.8 |
| 20 | | 98.0 | | | | | | 2 | 175.0 |
| 21 | | | 100 | | | | | | 173.4 |
| (comparative) | | | | | | | | | |
| 22 | | | 99.5 | | | | | 0.5 | 173.6 |
| 23 | | | 99.0 | | | | | 1 | 172.7 |
| 24 | | | 98.0 | | | | | 2 | 172.9 |
| 25 | | | | 100 | | | | | 179.0 |
| (comparative) | | | | | | | | | |
| 26 | | | | 99.5 | | | | 0.5 | 177.7 |
| 27 | | | | 99.0 | | | | 1 | 176.4 |
| 28 | | | | 98.0 | | | | 2 | 176.2 |
| 29 | | | | | 100 | | | | 180.1 |
| (comparative) | | | | | | | | | |
| 30 | | | | | 99.5 | | | 0.5 | 179.5 |
| 31 | | | | | 99.0 | | | 1 | 178.7 |
| 32 | | | | | 98.0 | | | 2 | 178.5 |
| 33 | | | | | | 100 | | | 184.3 |
| (comparative) | | | | | | | | | |
| 34 | | | | | | 99.5 | | 0.5 | 183.2 |
| 35 | | | | | | 99.0 | | 1 | 184.8 |
| 36 | | | | | | 98.0 | | 2 | 183.2 |
| 37 | | | | | | | 100 | | 180.3 |
| (comparative) | | | | | | | | | |
| 38 | | | | | | | 99.5 | 0.5 | 179.3 |
| 39 | | | | | | | 99.0 | 1 | 178.9 |
| 40 | | | | | | | 98.0 | 2 | 178.3 |

The % values are wt % values in each case.

TABLE 7
Melt viscosity at angular frequency of 471 to 0.503 [Hz]:

| | | Example | | | | | | | |
|---|---|---|---|---|---|---|---|---|---|
| Cone/plate | | 13 (com- | | | | 17 (com- | | | |
| rheology | | parison) | 14 | 15 | 16 | parison) | 18 | 19 | 20 |
| Melt visc. at | | | | | | | | | |
| 260° C. [Hz] | | | | | | | | | |
| 471 | Pa · s | 366 | 346 | 327 | 323 | 259 | 207 | 170 | 157 |
| 329 | Pa · s | 399 | 377 | 356 | 350 | 280 | 221 | 180 | 165 |
| 229 | Pa · s | 429 | 407 | 383 | 376 | 299 | 234 | 189 | 172 |
| 160 | Pa · s | 456 | 433 | 406 | 398 | 315 | 244 | 196 | 178 |
| 112 | Pa · s | 479 | 456 | 425 | 417 | 330 | 253 | 203 | 183 |
| 77.8 | Pa · s | 497 | 475 | 441 | 432 | 341 | 261 | 208 | 188 |
| 54.3 | Pa · s | 511 | 490 | 453 | 445 | 351 | 268 | 212 | 192 |
| 37.9 | Pa · s | 521 | 501 | 463 | 454 | 359 | 273 | 216 | 198 |
| 26.4 | Pa · s | 529 | 510 | 471 | 463 | 365 | 278 | 221 | 207 |
| 18.4 | Pa · s | 533 | 516 | 476 | 469 | 369 | 282 | 224 | 217 |
| 12.9 | Pa · s | 535 | 520 | 479 | 474 | 373 | 285 | 228 | 231 |
| 8.97 | Pa · s | 536 | 523 | 482 | 479 | 377 | 290 | 232 | 252 |
| 6.25 | Pa · s | 536 | 524 | 484 | 484 | 380 | 294 | 237 | 283 |
| 4.36 | Pa · s | 535 | 525 | 485 | 488 | 383 | 298 | 241 | 329 |
| 3.04 | Pa · s | 534 | 526 | 485 | 491 | 386 | 303 | 246 | 398 |
| 2.12 | Pa · s | 531 | 525 | 484 | 492 | 390 | 309 | 252 | 505 |
| 1.48 | Pa · s | 529 | 525 | 483 | 493 | 395 | 316 | 259 | 659 |
| 1.03 | Pa · s | 527 | 527 | 482 | 492 | 401 | 325 | 267 | 888 |
| 0.721 | Pa · s | 524 | 529 | 481 | 490 | 409 | 335 | 276 | 1230 |
| 0.503 | Pa · s | 519 | 531 | | 485 | 419 | 346 | 286 | 1700 |
| Melt visc. at | | | | | | | | | |
| 280° C. [Hz] | | | | | | | | | |
| 471 | Pa · s | 111 | 86 | 87 | 76 | 414 | 358 | 263 | 201 |
| 329 | Pa · s | 184 | 82 | 73 | 75 | 458 | 393 | 285 | 216 |
| 229 | Pa · s | 832 | 69 | 95 | 55 | 502 | 427 | 305 | 231 |
| 160 | Pa · s | 929 | 93 | 94 | 75 | 542 | 457 | 323 | 243 |
| 112 | Pa · s | 1020 | 945 | 865 | 854 | 577 | 484 | 338 | 254 |
| 77.8 | Pa · s | 1100 | 1020 | 928 | 914 | 608 | 507 | 350 | 263 |
| 54.3 | Pa · s | 1170 | 1080 | 983 | 966 | 635 | 526 | 360 | 271 |
| 37.9 | Pa · s | 1230 | 1130 | 1030 | 1010 | 656 | 541 | 368 | 278 |
| 26.4 | Pa · s | 1280 | 1170 | 1070 | 1050 | 674 | 554 | 374 | 286 |
| 18.4 | Pa · s | 1330 | 1200 | 1100 | 1080 | 686 | 563 | 380 | 290 |
| 12.9 | Pa · s | 1350 | 1230 | 1120 | 1100 | 696 | 570 | 385 | 296 |
| 8.97 | Pa · s | 1370 | 1250 | 1140 | 1120 | 703 | 576 | 390 | 302 |
| 6.25 | Pa · s | 1390 | 1260 | 1150 | 1130 | 708 | 580 | 395 | 309 |
| 4.36 | Pa · s | 1400 | 1270 | 1160 | 1150 | 712 | 584 | 400 | 317 |
| 3.04 | Pa · s | 1410 | 1280 | 1170 | 1160 | 716 | 588 | 405 | 325 |
| 2.12 | Pa · s | 1410 | 1280 | 1180 | 1170 | 718 | 592 | 410 | 333 |
| 1.48 | Pa · s | 1410 | 1290 | 1180 | 1180 | 722 | 597 | 416 | 343 |
| 1.03 | Pa · s | 1410 | 1290 | 1180 | 1180 | 725 | 603 | 424 | 353 |
| 0.721 | Pa · s | 1410 | 1280 | 1180 | 1190 | 729 | 612 | 434 | 365 |
| 0.503 | Pa · s | 1410 | 1280 | 1170 | 1180 | 733 | 624 | 446 | 379 |
| Melt visc. at | | | | | | | | | |
| 300° C. [Hz] | | | | | | | | | |
| 471 | Pa · s | 860 | 1040 | 880 | 1010 | 970 | 674 | 729 | 741 |
| 329 | Pa · s | 1150 | 1420 | 1290 | 1400 | 1200 | 906 | 835 | 879 |
| 229 | Pa · s | 1480 | 1820 | 1640 | 1800 | 1410 | 1120 | 945 | 1010 |
| 160 | Pa · s | 1910 | 2300 | 2160 | 2230 | 1610 | 1290 | 1050 | 1130 |
| 112 | Pa · s | 2400 | 2740 | 2660 | 2620 | 1790 | 1440 | 1150 | 1250 |
| 77.8 | Pa · s | 2850 | 3130 | 3070 | 2980 | 1970 | 1570 | 1230 | 1350 |
| 54.3 | Pa · s | 3200 | 3500 | 3430 | 3320 | 2140 | 1690 | 1310 | 1440 |
| 37.9 | Pa · s | 3530 | 3850 | 3760 | 3650 | 2280 | 1790 | 1370 | 1520 |
| 26.4 | Pa · s | 3830 | 4170 | 4070 | 3940 | 2410 | 1870 | 1420 | 1590 |
| 18.4 | Pa · s | 4100 | 4450 | 4340 | 4200 | 2510 | 1940 | 1470 | 1640 |
| 12.9 | Pa · s | 4340 | 4700 | 4580 | 4430 | 2600 | 2000 | 1500 | 1690 |
| 8.97 | Pa · s | 4540 | 4900 | 4770 | 4620 | 2660 | 2040 | 1520 | 1720 |
| 6.25 | Pa · s | 4700 | 5070 | 4930 | 4780 | 2710 | 2070 | 1540 | 1750 |
| 4.36 | Pa · s | 4830 | 5200 | 5060 | 4910 | 2750 | 2100 | 1560 | 1780 |
| 3.04 | Pa · s | 4940 | 5300 | 5160 | 5020 | 2770 | 2110 | 1570 | 1810 |
| 2.12 | Pa · s | 5020 | 5380 | 5240 | 5110 | 2790 | 2120 | 1580 | 1850 |
| 1.48 | Pa · s | 5080 | 5430 | 5300 | 5180 | 2800 | 2130 | 1600 | 1890 |
| 1.03 | Pa · s | 5110 | 5460 | 5340 | 5250 | 2810 | 2140 | 1610 | 1930 |
| 0.721 | Pa · s | 5130 | 5470 | 5370 | 5290 | 2810 | 2150 | 1620 | 1970 |
| 0.503 | Pa · s | 5130 | 5460 | 5360 | 5310 | 2800 | 2140 | 1630 | 2050 |
| | | Example | | | | | | | |
| Cone/plate | | 21 (com- | | | | 25 (com- | | | |
| rheology | | parison) | 22 | 23 | 24 | parison) | 26 | 27 | 28 |
| Melt visc. at | | | | | | | | | |
| 260° C. [Hz] | | | | | | | | | |
| 471 | | 132 | 85 | 71 | 71 | 296 | 221 | 182 | 133 |
| 329 | Pa · s | 140 | 89 | 73 | 73 | 322 | 238 | 194 | 140 |
| 229 | Pa · s | 146 | 92 | 75 | 75 | 348 | 254 | 204 | 146 |
| 160 | Pa · s | 152 | 95 | 76 | 76 | 371 | 268 | 211 | 150 |
| 112 | Pa · s | 157 | 96 | 77 | 76 | 390 | 279 | 217 | 154 |
| 77.8 | Pa · s | 160 | 98 | 77 | 77 | 407 | 289 | 222 | 156 |
| 54.3 | Pa · s | 164 | 99 | 78 | 77 | 420 | 296 | 225 | 158 |
| 37.9 | Pa · s | 167 | 100 | 78 | 78 | 431 | 301 | 227 | 159 |
| 26.4 | Pa · s | 171 | 102 | 79 | 79 | 439 | 305 | 229 | 161 |
| 18.4 | Pa · s | 173 | 102 | 79 | 79 | 444 | 307 | 230 | 162 |
| 12.9 | Pa · s | 176 | 103 | 80 | 80 | 448 | 308 | 231 | 163 |
| 8.97 | Pa · s | 180 | 104 | 80 | 80 | 451 | 309 | 231 | 165 |
| 6.25 | Pa · s | 186 | 105 | 81 | 81 | 452 | 309 | 231 | 166 |
| 4.36 | Pa · s | 194 | 108 | 82 | 82 | 454 | 309 | 231 | 167 |
| 3.04 | Pa · s | 206 | 111 | 83 | 84 | 455 | 309 | 231 | 169 |
| 2.12 | Pa · s | 222 | 116 | 85 | 86 | 456 | 309 | 231 | 171 |
| 1.48 | Pa · s | 244 | 123 | 89 | 89 | 458 | 310 | 233 | 173 |
| 1.03 | Pa · s | 272 | 133 | 93 | 93 | 461 | 311 | 235 | 177 |
| 0.721 | Pa · s | 307 | 147 | 98 | 99 | 466 | 314 | 238 | 183 |
| 0.503 | Pa · s | 354 | 167 | 105 | 105 | 472 | 317 | 244 | 191 |
| Melt visc. at | | | | | | | | | |
| 280° C. | | | | | | | | | |
| 471 | | 321 | 259 | 225 | 206 | 751 | 619 | 489 | 480 |
| 329 | Pa · s | 343 | 277 | 240 | 218 | 860 | 705 | 582 | 542 |
| 229 | Pa · s | 362 | 294 | 253 | 229 | 970 | 788 | 656 | 599 |
| 160 | Pa · s | 379 | 308 | 264 | 238 | 1080 | 865 | 718 | 649 |
| 112 | Pa · s | 392 | 320 | 273 | 244 | 1170 | 935 | 770 | 693 |
| 77.8 | Pa · s | 401 | 329 | 280 | 250 | 1260 | 996 | 814 | 731 |
| 54.3 | Pa · s | 407 | 336 | 286 | 253 | 1340 | 1050 | 849 | 761 |
| 37.9 | Pa · s | 411 | 341 | 290 | 257 | 1400 | 1090 | 877 | 786 |
| 26.4 | Pa · s | 414 | 346 | 294 | 259 | 1450 | 1120 | 898 | 806 |
| 18.4 | Pa · s | 415 | 349 | 297 | 262 | 1490 | 1140 | 915 | 821 |
| 12.9 | Pa · s | 415 | 352 | 300 | 265 | 1520 | 1160 | 928 | 834 |
| 8.97 | Pa · s | 416 | 355 | 303 | 268 | 1540 | 1170 | 937 | 846 |
| 6.25 | Pa · s | 416 | 357 | 306 | 272 | 1550 | 1180 | 945 | 857 |
| 4.36 | Pa · s | 416 | 359 | 309 | 275 | 1560 | 1190 | 952 | 868 |
| 3.04 | Pa · s | 417 | 363 | 313 | 278 | 1570 | 1190 | 958 | 881 |
| 2.12 | Pa · s | 418 | 366 | 316 | 281 | 1570 | 1190 | 960 | 891 |
| 1.48 | Pa · s | 421 | 370 | 321 | 285 | 1570 | 1200 | 963 | 901 |
| 1.03 | Pa · s | 425 | 377 | 327 | 289 | 1570 | 1200 | 967 | 910 |
| 0.721 | Pa · s | 431 | 385 | 336 | 295 | 1570 | 1200 | 967 | 917 |
| 0.503 | Pa · s | 439 | 395 | 346 | 303 | 1570 | 1190 | 965 | 922 |
| Melt visc. at | | | | | | | | | |
| 300° C. | | | | | | | | | |
| 471 | Pa · s | 648 | 533 | 507 | 489 | 913 | 1150 | 749 | 841 |
| 329 | Pa · s | 741 | 603 | 567 | 545 | 1260 | 1380 | 1030 | 985 |
| 229 | Pa · s | 831 | 669 | 623 | 598 | 1610 | 1630 | 1310 | 1140 |
| 160 | Pa · s | 917 | 730 | 675 | 648 | 2050 | 1890 | 1560 | 1290 |
| 112 | Pa · s | 997 | 784 | 720 | 691 | 2480 | 2160 | 1790 | 1450 |
| 77.8 | Pa · s | 1070 | 832 | 758 | 728 | 2850 | 2430 | 1980 | 1590 |
| 54.3 | Pa · s | 1130 | 871 | 788 | 758 | 3200 | 2700 | 2160 | 1720 |
| 37.9 | Pa · s | 1180 | 903 | 813 | 782 | 3520 | 2940 | 2320 | 1830 |
| 26.4 | Pa · s | 1220 | 928 | 831 | 800 | 3810 | 3150 | 2460 | 1920 |
| 18.4 | Pa · s | 1250 | 947 | 845 | 814 | 4070 | 3340 | 2570 | 1990 |
| 12.9 | Pa · s | 1270 | 962 | 856 | 826 | 4280 | 3490 | 2660 | 2050 |
| 8.97 | Pa · s | 1290 | 973 | 864 | 836 | 4460 | 3610 | 2730 | 2100 |
| 6.25 | Pa · s | 1300 | 984 | 871 | 845 | 4590 | 3700 | 2780 | 2130 |
| 4.36 | Pa · s | 1310 | 990 | 878 | 855 | 4690 | 3760 | 2820 | 2160 |
| 3.04 | Pa · s | 1320 | 996 | 885 | 866 | 4770 | 3820 | 2860 | 2190 |
| 2.12 | Pa · s | 1320 | 1000 | 890 | 876 | 4810 | 3850 | 2880 | 2210 |
| 1.48 | Pa · s | 1320 | 1010 | 895 | 887 | 4860 | 3880 | 2910 | 2240 |
| 1.03 | Pa · s | 1330 | 1010 | 900 | 895 | 4880 | 3910 | 2920 | 2260 |
| 0.721 | Pa · s | 1330 | 1020 | 903 | 901 | 4890 | 3920 | 2930 | 2280 |
| 0.503 | Pa · s | 1330 | 1030 | 904 | 903 | 4880 | 3910 | 2930 | 2290 |

| | | Example | | | | | | | |
|---|---|---|---|---|---|---|---|---|---|
| Cone/plate | | 29 | | | | 33 | | | |
| rheology | | (comp.) | 30 | 31 | 32 | (comp.) | 34 | 35 | 36 |
| Melt visc. at | | | | | | | | | |
| 260° C. [Hz] | | | | | | | | | |
| 471 | Pa · s | 268 | 188 | 187 | 162 | 333 | 403 | 302 | 294 |
| 329 | Pa · s | 292 | 203 | 198 | 171 | 369 | 442 | 328 | 319 |
| 229 | Pa · s | 317 | 218 | 208 | 179 | 404 | 478 | 352 | 342 |
| 160 | Pa · s | 339 | 230 | 216 | 185 | 438 | 510 | 372 | 362 |
| 112 | Pa · s | 358 | 241 | 222 | 190 | 468 | 538 | 389 | 379 |
| 77.8 | Pa · s | 375 | 250 | 226 | 193 | 495 | 560 | 403 | 392 |
| 54.3 | Pa · s | 388 | 257 | 229 | 196 | 517 | 578 | 413 | 402 |
| 37.9 | Pa · s | 400 | 262 | 231 | 198 | 536 | 592 | 421 | 410 |
| 26.4 | Pa · s | 413 | 266 | 233 | 199 | 557 | 603 | 428 | 417 |
| 18.4 | Pa · s | 418 | 270 | 233 | 201 | 566 | 611 | 433 | 422 |
| 12.9 | Pa · s | 426 | 272 | 234 | 202 | 575 | 616 | 437 | 428 |
| 8.97 | Pa · s | 433 | 274 | 235 | 203 | 583 | 620 | 441 | 433 |
| 6.25 | Pa · s | 441 | 275 | 235 | 204 | 590 | 624 | 445 | 439 |
| 4.36 | Pa · s | 451 | 276 | 235 | 205 | 597 | 626 | 448 | 444 |
| 3.04 | Pa · s | 464 | 278 | 236 | 206 | 604 | 628 | 451 | 449 |
| 2.12 | Pa · s | 482 | 281 | 236 | 206 | 613 | 629 | 454 | 454 |
| 1.48 | Pa · s | 509 | 285 | 236 | 207 | 627 | 630 | 457 | 458 |
| 1.03 | Pa · s | 547 | 292 | 237 | 209 | 648 | 631 | 460 | 462 |
| 0.721 | Pa · s | 599 | 303 | 239 | 212 | 680 | 631 | 465 | 466 |
| 0.503 | Pa · s | 673 | 319 | 240 | 216 | 734 | 631 | 471 | 472 |
| Melt visc. at | | | | | | | | | |
| 280° C. [Hz] | | | | | | | | | |
| 471 | Pa · s | 642 | 556 | 513 | 468 | 630 | 693 | 627 | 588 |
| 329 | Pa · s | 748 | 647 | 583 | 521 | 818 | 805 | 714 | 667 |
| 229 | Pa · s | 846 | 727 | 647 | 570 | 1010 | 918 | 804 | 748 |
| 160 | Pa · s | 934 | 798 | 704 | 614 | 1190 | 1030 | 889 | 825 |
| 112 | Pa · s | 1020 | 862 | 754 | 652 | 1330 | 1130 | 967 | 896 |
| 77.8 | Pa · s | 1090 | 917 | 796 | 683 | 1450 | 1230 | 1040 | 959 |
| 54.3 | Pa · s | 1150 | 964 | 831 | 707 | 1570 | 1310 | 1100 | 1010 |
| 37.9 | Pa · s | 1200 | 1000 | 858 | 725 | 1660 | 1380 | 1150 | 1060 |
| 26.4 | Pa · s | 1240 | 1030 | 879 | 739 | 1750 | 1440 | 1190 | 1090 |
| 18.4 | Pa · s | 1270 | 1050 | 895 | 750 | 1810 | 1480 | 1220 | 1120 |
| 12.9 | Pa · s | 1290 | 1070 | 907 | 758 | 1860 | 1520 | 1240 | 1140 |
| 8.97 | Pa · s | 1300 | 1080 | 917 | 764 | 1900 | 1540 | 1260 | 1160 |
| 6.25 | Pa · s | 1310 | 1090 | 925 | 771 | 1930 | 1560 | 1270 | 1180 |
| 4.36 | Pa · s | 1320 | 1100 | 931 | 778 | 1950 | 1580 | 1280 | 1190 |
| 3.04 | Pa · s | 1320 | 1100 | 937 | 785 | 1960 | 1590 | 1290 | 1210 |
| 2.12 | Pa · s | 1320 | 1110 | 941 | 789 | 1970 | 1590 | 1300 | 1220 |
| 1.48 | Pa · s | 1330 | 1110 | 945 | 794 | 1970 | 1600 | 1310 | 1230 |
| 1.03 | Pa · s | 1330 | 1120 | 949 | 798 | 1980 | 1600 | 1310 | 1240 |
| 0.721 | Pa · s | 1330 | 1120 | 952 | 801 | 1980 | 1600 | 1320 | 1250 |
| 0.503 | Pa · s | 1330 | 1120 | 953 | 801 | 1980 | 1600 | 1310 | 1250 |
| Melt visc. at | | | | | | | | | |
| 300° C. [Hz] | | | | | | | | | |
| 471 | Pa · s | 862 | 1100 | 787 | 826 | 993 | 1000 | 1080 | 997 |
| 329 | Pa · s | 1210 | 1300 | 1090 | 1100 | 1450 | 1420 | 1480 | 1280 |
| 229 | Pa · s | 1560 | 1520 | 1390 | 1350 | 1880 | 1870 | 1850 | 1540 |
| 160 | Pa · s | 1960 | 1750 | 1690 | 1570 | 2540 | 2390 | 2210 | 1810 |
| 112 | Pa · s | 2330 | 1990 | 1960 | 1780 | 3190 | 2860 | 2560 | 2080 |
| 77.8 | Pa · s | 2660 | 2230 | 2190 | 1970 | 3770 | 3300 | 2920 | 2350 |
| 54.3 | Pa · s | 2960 | 2450 | 2390 | 2150 | 4290 | 3720 | 3260 | 2620 |
| 37.9 | Pa · s | 3230 | 2650 | 2580 | 2310 | 4810 | 4130 | 3590 | 2880 |
| 26.4 | Pa · s | 3480 | 2820 | 2740 | 2450 | 5310 | 4510 | 3880 | 3110 |
| 18.4 | Pa · s | 3700 | 2970 | 2870 | 2560 | 5770 | 4850 | 4150 | 3310 |
| 12.9 | Pa · s | 3880 | 3090 | 2980 | 2650 | 6180 | 5150 | 4370 | 3490 |
| 8.97 | Pa · s | 4020 | 3180 | 3070 | 2730 | 6540 | 5410 | 4550 | 3620 |
| 6.25 | Pa · s | 4130 | 3250 | 3140 | 2790 | 6830 | 5610 | 4700 | 3730 |
| 4.36 | Pa · s | 4210 | 3300 | 3190 | 2830 | 7060 | 5780 | 4820 | 3810 |
| 3.04 | Pa · s | 4270 | 3340 | 3230 | 2880 | 7240 | 5900 | 4910 | 3880 |
| 2.12 | Pa · s | 4310 | 3370 | 3260 | 2910 | 7380 | 6000 | 4980 | 3940 |
| 1.48 | Pa · s | 4350 | 3390 | 3290 | 2940 | 7480 | 6080 | 5040 | 3990 |
| 1.03 | Pa · s | 4360 | 3410 | 3310 | 2980 | 7550 | 6130 | 5090 | 4040 |
| 0.721 | Pa · s | 4380 | 3420 | 3330 | 3010 | 7590 | 6170 | 5130 | 4070 |
| 0.503 | Pa · s | 4370 | 3410 | 3330 | 3020 | 7600 | 6180 | 5140 | 4100 |

Example

| Cone/plate | | 37 | | | |
|---|---|---|---|---|---|
| rheology | | (comp.) | 38 | 39 | 40 |
| Melt viscosity | | | | | |
| at 260° C. [Hz] | | | | | |
| 471 | Pas | 391 | 344 | 285 | 250 |
| 329 | Pas | 430 | 375 | 308 | 270 |
| 229 | Pas | 467 | 404 | 329 | 288 |
| 160 | Pas | 500 | 429 | 347 | 302 |
| 112 | Pas | 528 | 450 | 362 | 314 |
| 77.8 | Pas | 552 | 468 | 374 | 324 |
| 54.3 | Pas | 570 | 481 | 382 | 331 |
| 37.9 | Pas | 584 | 491 | 389 | 337 |
| 26.4 | Pas | 595 | 498 | 394 | 341 |
| 18.4 | Pas | 601 | 502 | 397 | 345 |
| 12.9 | Pas | 604 | 505 | 399 | 348 |
| 8.97 | Pas | 606 | 507 | 401 | 351 |
| 6.25 | Pas | 607 | 507 | 402 | 354 |
| 4.36 | Pas | 606 | 507 | 403 | 357 |
| 3.04 | Pas | 606 | 508 | 403 | 360 |
| 2.12 | Pas | 603 | 506 | 403 | 362 |
| 1.48 | Pas | 602 | 505 | 403 | 363 |
| 1.03 | Pas | 601 | 505 | 403 | 365 |
| 0.721 | Pas | 599 | 504 | 403 | 368 |
| 0.503 | Pas | 595 | 501 | 403 | 371 |
| Melt viscosity | | | | | |
| at 280° C. [Hz] | | | | | |
| 471 | Pas | 657 | 670 | 534 | 588 |
| 329 | Pas | 838 | 768 | 653 | 681 |
| 229 | Pas | 1010 | 868 | 758 | 767 |
| 160 | Pas | 1160 | 965 | 850 | 848 |
| 112 | Pas | 1300 | 1060 | 927 | 921 |
| 77.8 | Pas | 1420 | 1140 | 995 | 985 |
| 54.3 | Pas | 1530 | 1220 | 1050 | 1040 |
| 37.9 | Pas | 1620 | 1280 | 1100 | 1090 |
| 26.4 | Pas | 1700 | 1330 | 1140 | 1130 |
| 18.4 | Pas | 1770 | 1380 | 1180 | 1160 |
| 12.9 | Pas | 1820 | 1410 | 1200 | 1180 |
| 8.97 | Pas | 1860 | 1440 | 1220 | 1200 |
| 6.25 | Pas | 1890 | 1450 | 1230 | 1210 |
| 4.36 | Pas | 1910 | 1470 | 1240 | 1230 |
| 3.04 | Pas | 1920 | 1480 | 1250 | 1240 |
| 2.12 | Pas | 1930 | 1480 | 1260 | 1250 |
| 1.48 | Pas | 1930 | 1480 | 1260 | 1260 |
| 1.03 | Pas | 1930 | 1480 | 1260 | 1270 |
| 0.721 | Pas | 1930 | 1480 | 1260 | 1270 |
| 0.503 | Pas | 1920 | 1470 | 1250 | 1270 |
| Melt viscosity | | | | | |
| at 300° C. [Hz] | | | | | |
| 471 | Pas | 999 | 1340 | 1060 | 880 |
| 329 | Pas | 1430 | 1610 | 1330 | 1220 |
| 229 | Pas | 1870 | 1920 | 1590 | 1520 |
| 160 | Pas | 2360 | 2260 | 1870 | 1820 |
| 112 | Pas | 2820 | 2610 | 2160 | 2100 |
| 77.8 | Pas | 3260 | 2980 | 2450 | 2370 |
| 54.3 | Pas | 3700 | 3340 | 2730 | 2620 |
| 37.9 | Pas | 4130 | 3690 | 2990 | 2860 |
| 26.4 | Pas | 4540 | 4010 | 3230 | 3070 |
| 18.4 | Pas | 4920 | 4300 | 3450 | 3250 |
| 12.9 | Pas | 5270 | 4560 | 3630 | 3400 |
| 8.97 | Pas | 5570 | 4770 | 3790 | 3530 |
| 6.25 | Pas | 5830 | 4950 | 3910 | 3640 |
| 4.36 | Pas | 6030 | 5090 | 4000 | 3720 |
| 3.04 | Pas | 6200 | 5210 | 4080 | 3800 |
| 2.12 | Pas | 6320 | 5290 | 4140 | 3850 |
| 1.48 | Pas | 6420 | 5350 | 4180 | 3900 |
| 1.03 | Pas | 6480 | 5400 | 4210 | 3940 |
| 0.721 | Pas | 6510 | 5420 | 4230 | 3980 |
| 0.503 | Pas | 6520 | 5420 | 4230 | 4010 |

Table 7 shows that compared to the inventive examples in the table, the comparative examples 13, 17, 21, 25, 29, 33 and 37 which do not comprise the PE wax exhibit higher melt viscosities and thus have poorer flowability at the three measurement temperatures.

1.-15. (canceled)

16. A composition comprising
A) 67.0 to 99.95 wt % of one or more copolycarbonates comprising monomer units selected from the group consisting of the structural units of general formulae (1a), (1b), (1c) and (1d) 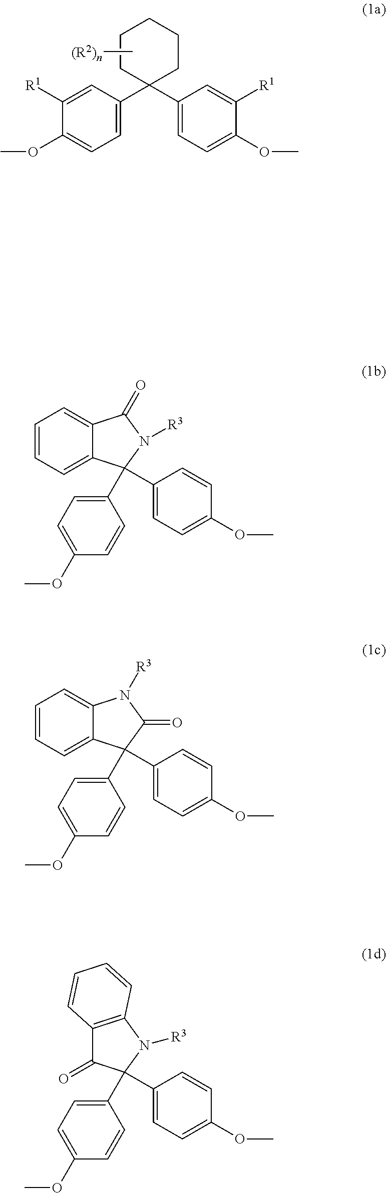
in which
R¹ represents hydrogen or C₁-C₄-alkyl,
R2 represents C1-C4-alkyl,
n represents 0, 1, 2 or 3 and
R³ represents C₁-C₄-alkyl, aralkyl or aryl,
or
67.0 to 99.95 wt % of a blend of the one or more copolycarbonates and at least one further homo- or copolycarbonate comprising one or more monomer units of general formula (2): 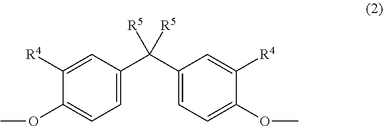
in which
R⁴ represents H, linear or branched C₁-C₁₀(alkyl and
R⁵ represents linear or branched C₁-C₁₀alkyl;
wherein the optionally present further homo- or copolycarbonate has no monomer units of formulae (1a), (1b), (1c) and (1d);
B) 0.05 to 10.0 wt % of at least one oxidized acid-modified polyethylene wax; and
C) optionally one or more additives and/or fillers in a total amount of up to 30.0 wt %.

17. The composition as claimed in claim 16, wherein the oxidation index of the oxidized acid-modified polyethylene wax is greater than 8.

18. The composition as claimed in claim 16, wherein the oxidized acid-modified polyethylene wax has an acid number between 0.5 and 20 mg KOH/g, a crystallinity of not less than 60% and not more than 90% and a melting temperature between 90° C. and 130° C.

19. The composition as claimed in claim 16, wherein the oxidized acid-modified polyethylene wax has a melt viscosity, determined as per ISO 11443, between 70 mPa·s and 800 mPa·s.

20. The composition as claimed in claim 16, wherein the amount of oxidized acid-modified polyethylene wax is 0.10 to 5.0 wt %.

21. The composition as claimed in claim 16, wherein the total proportion of the monomer units of formulae (1a), (1 b), (1c) and (1d) in the copolycarbonate is 0.1-88 mol % (based on the sum of the diphenol monomer units present therein).

22. The composition as claimed in claim 16, wherein the composition comprises the one or more copolycarbonates comprising one or more monomer units of formulae (1a), (1b), (1c) and/or (1d) in an amount of at least 60 wt %.

23. The composition as claimed in claim 16, wherein the copolycarbonate comprising the monomer units of formulae (1a), (1b), (1c) and/or (1d) further comprises monomer units of formula (3) 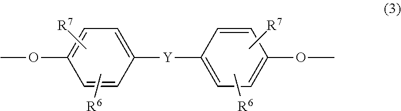
in which
R⁶ and R⁷ independently of one another represent H, C₁-C₁₈-alkyl-, C₁-C₁₈-alkoxy, halogen such as Cl or Br or respectively optionally substituted aryl or aralkyl and
Y represents a single bond, —SO₂—, —CO—, —O—, —S—, C₁-C₆-alkylene or C₂-C₅-alkylidene, furthermore C₆-C₁₂-arylene, which may optionally be fused with further heteroatom-comprising aromatic rings.

24. The composition as claimed in claim 16, wherein the copolycarbonate comprises monomer units derived from compounds of general formulae (1a″), (1b′), (1c′) and/or (1d′) in combination with monomer units derived from compounds of general formula (3c), 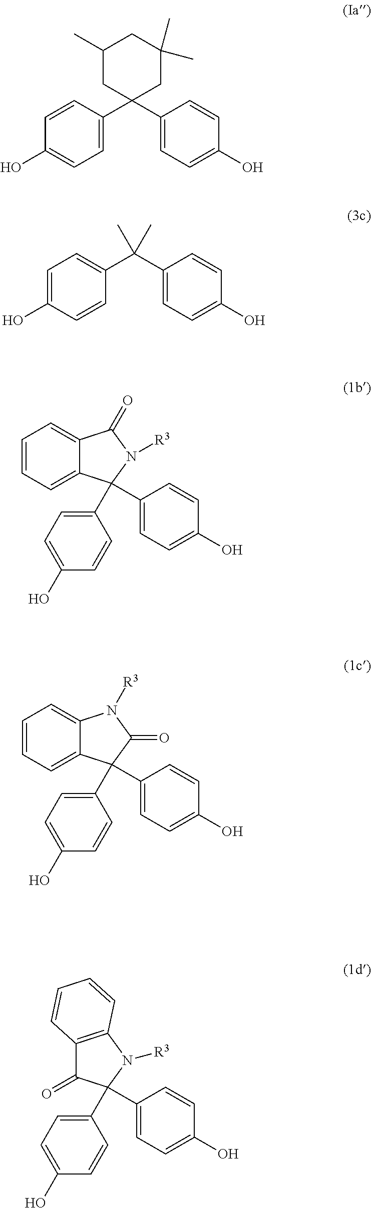
wherein R³ is methyl or phenyl.

25. The composition as claimed in claim 16, wherein the composition comprises as component A) a blend of the copolycarbonate and the further homo- or copolycarbonate comprising one or more monomer units of general formula (2), wherein R⁴ represents H and R⁵ represents linear or branched C₁-C₆ alkyl.

26. The composition as claimed in claim 16, wherein the composition comprises one or more additives selected from the group consisting of thermal stabilizers, demolding agents and UV stabilizers.

27. The composition according to claim 16, wherein the composition comprises an inorganic filler.

28. The composition as claimed in claim 16, wherein the composition comprises 0.002 to 0.2 wt % of thelinal stabilizer, 0.01 wt % to 1.00 wt % of UV stabilizer and 0.05 wt % to 2.00 wt % of demolding agent.

29. A blend, molding, extrudate, film or film laminate obtainable from copolycarbonate compositions as claimed in claim 16 or else a molding, extrudate or film comprising coextrusion layers obtainable from copolycarbonate compositions as claimed in claim 16.

30. A method comprising utilizing oxidized acid-modified polyethylene waxes for improving the flowability of compositions comprising a copolycarbonate as claimed in claim 16 or a blend of the copolycarbonate and a further homo- or copolycarbonate as claimed in claim 16.
